(19) United States
(12) Patent Application Publication
(10) Pub. No.: US 2015/0244813 A1
(43) Pub. Date: Aug. 27, 2015

(54) SESSION CONTROL SYSTEM, COMMUNICATION SYSTEM, SESSION CONTROL METHOD, AND RECORDING MEDIUM STORING SESSION CONTROL PROGRAM

(71) Applicant: Hideki TAMURA, Kanagawa (JP)

(72) Inventor: Hideki TAMURA, Kanagawa (JP)

(21) Appl. No.: 14/618,119

(22) Filed: Feb. 10, 2015

(30) Foreign Application Priority Data
Feb. 21, 2014 (JP) 2014-031510

(51) Int. Cl. H04L 29/08

(52) U.S. Cl. CPC H04L 67/141

(57) ABSTRACT

A session control system stores, in a memory, limitation information for each one of a plurality of first sessions where participatable terminals that can participate in the session are limited. The limitation information includes: participatable terminal identification information for identifying each one of participatable terminals allowed to participate in the first session; and participant terminal identification information for identifying each one of the participatable terminals that is participating in the first session. In response to receiving a request for starting a second session with a counterpart terminal by a first terminal, the session control system determines whether the counterpart terminal is participating in any one of the first sessions using the participant terminal identification information, and accepts the request to enable the first terminal to start the second session, when the counterpart terminal is not participating in any one of the first sessions.

### CROSS-REFERENCE TO RELATED APPLICATIONS

This patent application is based on and claims priority pursuant to 35 U.S.C. §119(a) to Japanese Patent Application No. 2014-031510, filed on Feb. 21, 2014, in the Japan Patent Office, the entire disclosure of which is hereby incorporated by reference herein.

### BACKGROUND

1. Technical Field

The present invention relates to controlling sessions for transmitting content data between communication terminals.

2. Description of the Related Art

Communication systems that perform a videoconference or the like via a communication network such as the Internet have become popular in recent years due to a demand for reducing business trip costs and time. When communication is started between a plurality of communication terminals in such a communication system, image data and sound data are transmitted/received, thereby realizing a videoconference.

In some conferences, highly confidential data is transmitted/received. There has been a demand for technology that can appropriately limit participants in such conferences. An example of such technology for limiting participants in a conference includes JP 7-177482-A, which discloses technology for registering participants before a conference starts and limiting the participants to those registered in advance.

### SUMMARY

Example embodiments of the present invention include a session control system that stores, in a memory, limitation information for each one of a plurality of first sessions where participatable communication terminals that can participate in the session are limited. The limitation information includes: participatable terminal identification information for identifying each one of participatable communication terminals allowed to participate in the first session; and participant terminal identification information for identifying each one of the participatable communication terminals that is participating in the first session. In response to receiving a request for starting a second session with a counterpart communication terminal by a first communication terminal, the session control system determines whether the counterpart communication terminal is participating in any one of the first sessions using the participant terminal identification information, and accepts the request to enable the first communication terminal to start the second session with the counterpart communication terminal, when the counterpart communication terminal is not participating in any one of the first sessions.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram of a communication system according to an embodiment of the present invention;

FIG. 2 is an illustration of transmission/reception of image data, sound data, and various types of management information in the communication system of FIG. 1;

FIG. 3 is an external view of a communication terminal of the communication system of FIG. 1;

FIG. 4 is a hardware configuration diagram of the communication terminal of FIG. 4;

FIG. 5 is a hardware configuration diagram of a communication management system, a relay device, a program providing system, a maintenance system, or a communication terminal management system in the communication system of FIG. 1;

FIG. 6 is a functional block diagram of the communication terminal, the communication management system, and the communication terminal management system of the communication system of FIG. 1;

FIG. 7 is an illustration of a terminal authentication management table;

FIG. 8 is an illustration of a terminal management table;

FIG. 9 is an illustration of a candidate list management table;

FIG. 10 is an illustration of a session management table;

FIG. 11 is an illustration of a limitation information management table;

FIG. 12 is an illustration of transmission/reception of various types of information in the communication system of FIG. 1;

FIG. 13 is a sequence diagram illustrating operation of processing a conference setting request received from a user personal computer (PC) terminal;

FIG. 14 is an illustration of a candidate list;

FIGS. 15A and 15B (FIG. 15) are a sequence diagram illustrating operation of preparing to start communication between communication terminals;

FIG. 16 is an illustration of a candidate list;

FIGS. 17A and 17B (FIG. 17) are a sequence diagram illustrating operation of processing a request for starting communication;

FIG. 18 is a flowchart illustrating operation of determining whether to permit a request for starting communication;

FIGS. 19A and 19B (FIG. 19) is a sequence diagram illustrating operation of processing a participation request from a communication terminal that requests to participate in a content data session;

FIG. 20 is a flowchart illustrating operation of determining whether to allow participation;

FIG. 21 is an illustration of an example of an error message; and

FIG. 22 is an illustration of an example of a display screen.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Hereinafter, an embodiment of the present invention will be described using the drawings.

### <Overall Configuration of Communication System>

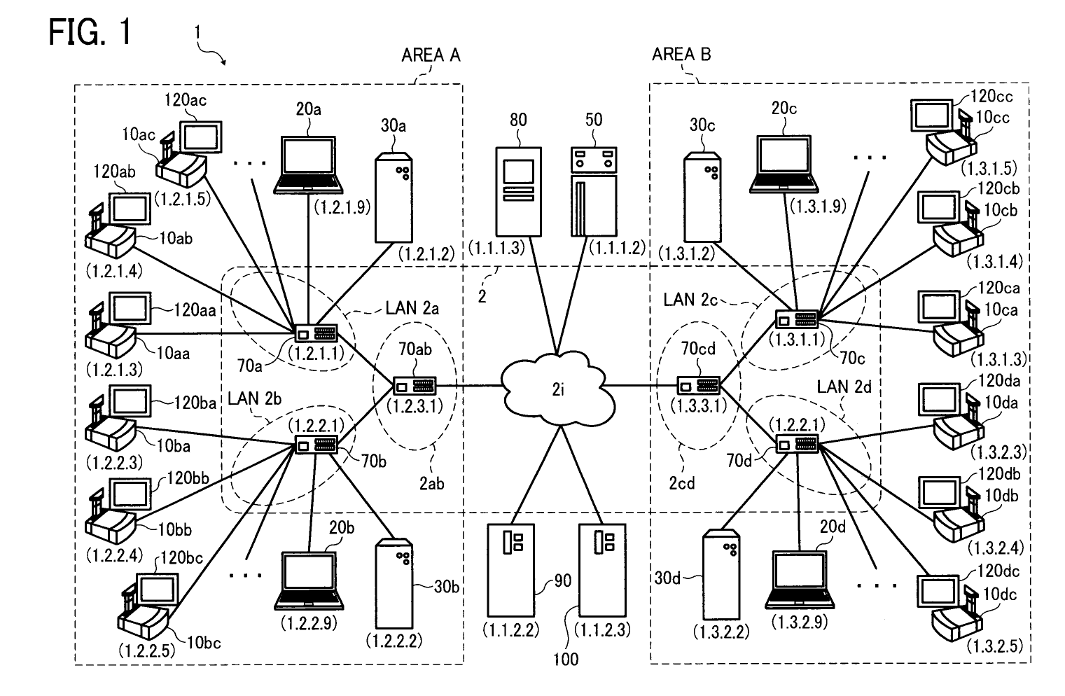

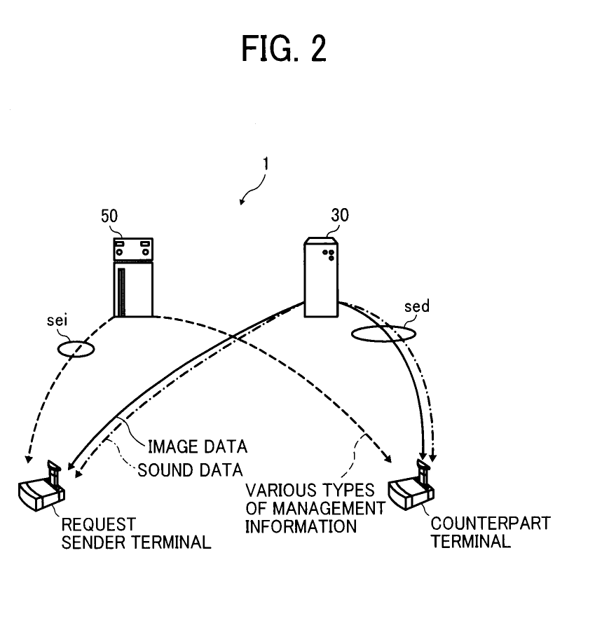

FIG. 1 is a schematic diagram of a communication system 1 according to an embodiment of the present invention. FIG. 2 is an illustration of transmission/reception of image data, sound data, and various types of information in the communication system.

The communication system 1 includes a communication system that intercommunicates information, information that reflects feelings, or the like between a plurality of communication terminals 10 via a communication management system 50. Examples of the communication system include a videoconference system and a teleconference system.

In the embodiment, the communication system, the communication management system, and the communication terminal will be described while assuming a videoconference system serving as an example of the communication system, a videoconference management system serving as the communication management system, and a videoconference terminal serving as an example of the communication terminal. That is, the communication terminal and the communication management system according to the embodiment of the present invention are applied not only to a videoconference system, but also to another communication system. Although the example in the embodiment is described as a “videoconference”, this may alternatively be referred to as a “teleconference”.

Also in the embodiment, the case in which users in the communication system 1 include four offices, namely, a Tokyo office (user a), an Osaka office (user b), a New York office (user c), and a Washington D.C. office (user d), will be described.

First, the communication system 1 illustrated in FIG. 1 includes the plurality of communication terminals (10aa, 10ab, . . . ), displays (120aa, 120ab, . . . ) for the individual communication terminals (10aa, 10ab, . . . ), a plurality of user PC terminals (20a, 20b, 20c, and 20d), a plurality of relay devices (30a, 30b, 30c, and 30d), the communication management system 50, a communication terminal management system 80, a program providing system 90, and a maintenance system 100.

The plurality of communication terminals 10 perform communication by transmitting and receiving image data and sound data serving as examples of content data.

Hereinafter, the “communication terminal” is simply represented as the “terminal”. In addition, an arbitrary one or ones of the plurality of terminals (10aa, 10ab, . . . ) is/are represented as a “terminal(s) 10”. An arbitrary one or ones of the plurality of displays (120aa, 120ab, . . . ) is/are represented as a “display(s) 120”. An arbitrary one or ones of the plurality of relay devices (30a, 30b, 30c, and 30d) is/are represented as a “relay device(s) 30”. Further, a terminal serving as a request sender that gives a request to start a videoconference is represented as a “request sender terminal”, and a terminal serving as a counterpart terminal that is a request destination (relay destination) is represented as a “counterpart terminal”. In the following description, the user PC terminals (20a, 20b, 20c, and 20d) are respectively represented as “PCs (20a, 20b, 20c, and 20d)”, and further, an arbitrary one or ones of the PCs is/are represented as a “PC(s) 20”.

In addition, as illustrated in FIG. 2, a management information session sei for transmitting and receiving various types of management information is established via the communication management system 50 between a request sender terminal and a counterpart terminal in the communication system 1. Individual sessions for transmitting and receiving image data and sound data via a corresponding one of the relay devices 30 are also established between the request sender terminal and the counterpart terminal. Here, these sessions are collectively indicated as a content data session sed.

The relay devices 30 illustrated in FIG. 1 relay content data between the plurality of terminals 10. The communication management system 50 collectively manages login authentication from the terminals 10, the communication states, candidate lists, and so forth of the terminals 10, and the communication states and so forth of the relay devices 30. Note that an image of image data may be a moving image or a still image, or may include both thereof.

A plurality of routers (70a, 70b, 70c, 70d, 70ab, and 70cd) select an optimal path for image data and sound data. Hereinafter, an arbitrary one or ones of the routers (70a, 70b, 70c, 70d, 70ab, and 70cd) is/are represented as a “router(s) 70”.

The program providing system 90 includes a hard disk (HD) 204 described later. The HD 204 stores a terminal control program for causing a terminal 10 to realize various functions (or for causing a terminal 10 to function as various elements), and the terminal control program can be transmitted to the terminal 10. In addition, the HD 204 of the program providing system 90 stores a relay device control program for causing a relay device 30 to realize various functions (or for causing a relay device 30 to function as various elements), and the relay device control program can be transmitted to the relay device 30. Further, the HD 204 of the program providing system 90 stores a communication management program for causing the communication management system 50 to realize various functions (or for causing the communication management system 50 to function as various elements), and the communication management program can be transmitted to the communication management system 50.

The maintenance system 100 is one or more computers for performing maintenance, management, or conservation of at least one of the terminals 10, the relay devices 30, the communication management system 50, and the program providing system 90. For example, in the case where the maintenance system 100 is located in one country, and the terminals 10, the relay devices 30, the communication management system 50, or the program providing system 90 is/are located outside that country, the maintenance system 100 remotely performs, via a communication network 2, maintenance, management, or conservation of at least one of the terminals 10, the relay devices 30, the communication management system 50, and the program providing system 90. In addition, the maintenance system 100 performs maintenance such as management of the model number, serial number, sales contact, maintenance checkup, or a past history of failures of at least one of the terminals 10, the relay devices 30, the communication management system 50, and the program providing system 90 without having the communication network 2 therebetween.

The terminals (10aa, 10ab, 10ac, . . . ), the PC 20a, the relay device 30a, and the router 70a are connected to be communicable with each other by a local area network (LAN) 2a. The terminals (10ba, 10bb, 10bc, . . . ), the PC 20b, the relay device 30b, and the router 70b are connected to be communicable with each other by a LAN 2b. In addition, the LAN 2a and the LAN 2b are connected to be communicable with each other by a dedicated line 2ab including the router 70ab and are configured in a certain area A. For example, the area A is Japan, the LAN 2a is configured in the office in Tokyo, and the LAN 2b is configured in the office in Osaka.

The terminals (10ca, 10cb, 10cc, . . . ), the PC 20c, the relay device 30c, and the router 70c are connected to be communicable with each other by a LAN 2c. The terminals (10da, 10db, 10dc, . . . ), the PC 20d, the relay device 30d, and the router 70d are connected to be communicable with each other by a LAN 2d. In addition, the LAN 2c and the LAN 2d are connected to be communicable with each other by a dedicated line 2cd including the router 70cd and are configured in a certain area B. For example, the area B is the United States, the LAN 2c is configured in the office in New York, and the LAN 2d is configured in the office in Washington D.C. The area A and the area B are connected to be communicable with each other from the routers (70ab and 70cd), respectively, via the Internet 2i.

In addition, the communication management system 50, the communication terminal management system 80, and the program providing system 90 are connected to be communicable with the terminals 10, the PCs 20, and the relay devices 30 via the Internet 2i. The communication management system 50, the communication terminal management system 80, and the program providing system 90 may be located in the area A or the area B, or may be located in other areas.

In the embodiment, the communication network 2 of the embodiment includes the LAN 2a, the LAN 2b, the dedicated line 2ab, the Internet 2i, the dedicated line 2cd, the LAN 2c, and the LAN 2d. The communication network 2 may include not only a wired network, but also a network where communication is performed wirelessly, such as Wireless Fidelity (WiFi) or Bluetooth (registered trademark).

In addition in FIG. 1, four digits indicated below each of the terminals 10, each of the relay devices 30, the communication management system 50, each of the routers 70, and the program providing system 90 indicates an IP address in an abbreviated form in the general Internet Protocol version 4 (IPv4). For example, the IP address of the terminal 10aa is “1.2.1.3”. Although IPv6 may be used instead of IPv4, IPv4 is used in order to make the description simple.

Note that the terminals 10 may be used not only for communication between different offices or for communication between different rooms in the same office, but also for communication within the same room or for outdoor-indoor communication or outdoor-outdoor communication. In the case where the terminals 10 are used outside, wireless communication using a mobile phone communication network or the like is performed.

### <Hardware Configuration of Communication System>

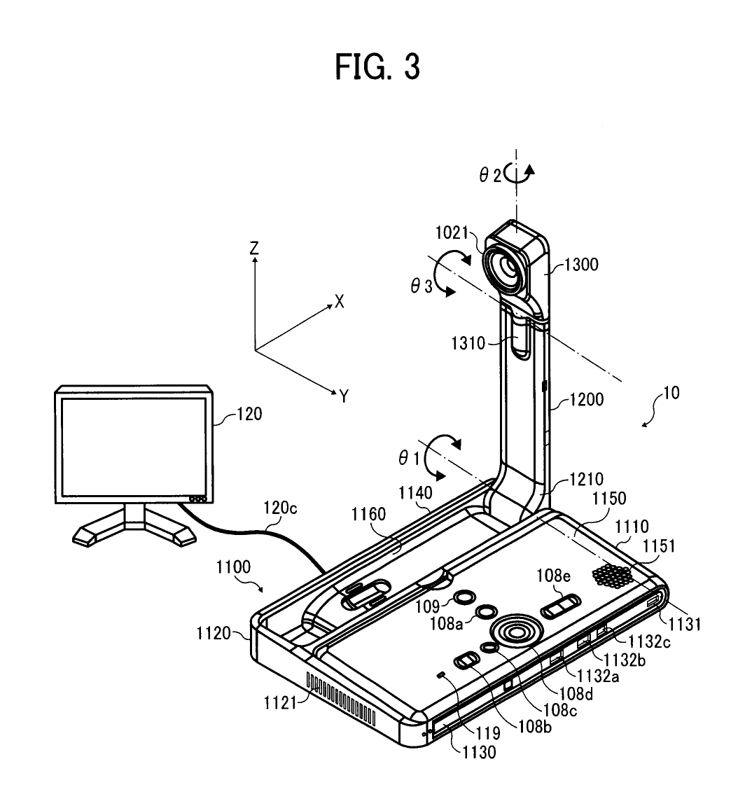

Next, the hardware configuration of the embodiment will be described. FIG. 3 is an external view of a terminal 10 according to the embodiment. The description will be given assuming that the longitudinal direction of the terminal 10 is the X-axis direction, a direction orthogonal to the X-axis direction on one plane is the Y-axis direction, and a direction orthogonal to the X-axis direction and the Y-axis direction (vertical direction) is the Z-axis direction.

As illustrated in FIG. 3, the terminal 10 includes a casing 1100, an arm 1200, and a camera housing 1300. Among these portions, a front wall 1110 of the casing 1100 has an inlet face including a plurality of inlet holes, and a back wall 1120 of the casing 1100 has an exhaust face 1121 on which a plurality of exhaust holes are formed. Accordingly, by driving of a cooling fan included in the casing 1100, air behind the terminal 10 can be taken in via the inlet face and exhausted to the rear of the terminal 10 via the exhaust face 1121. A right-side wall 1130 of the casing 1100 has a sound pickup hole 1131 formed thereon, and a built-in microphone 114, described later, is capable of picking up sound and noise.

An operation panel 1150 is formed toward the right-side wall 1130 of the casing 1100. The operation panel 1150 has a plurality of operation keys (108a to 108e) described later, a power switch 109 described later, and an alarm lamp 119 described later, which are formed thereon. The operation panel 1150 also has a sound output face 1151 formed thereon, which is formed of a plurality of sound output holes for allowing output sound from a built-in speaker 115, described later, to pass through. In addition, an accommodation portion 1160 serving as a recess for accommodating the arm 1200 and the camera housing 1300 is formed toward a left-side wall 1140 of the casing 1100. A plurality of connection ports (1132a to 1132c) for electrically connecting cables to an external device connection interface (I/F) 118 described later are provided on the right-side wall 1130 of the casing 1100. In contrast, a connection port for electrically connecting a cable 120c for a display 120 to the external device connection I/F 118 described later is provided toward the left-side wall 1140 of the casing 1100.

The following description uses the term “operation key(s) 108” for indicating an arbitrary one or ones of the operation keys (108a to 108e), and the term “connection port(s) 1132” for indicating an arbitrary one or ones of the connection ports (1132a to 1132c). Next, the arm 1200 is attached to the casing 1100 via a torque hinge 1210 and is configured to be rotatable in the vertical direction within a range of a tilt angle θ1 of 135 degrees with respect to the casing 1100. FIG. 3 indicates a state in which the tilt angle θ1 is 90 degrees.

The camera housing 1300 has a built-in camera 112 provided thereon, which will be described later, and the camera 112 can capture an image of a user, a document, a room, or the like. In addition, the camera housing 1300 has a torque hinge 1310 formed thereon. The camera housing 1300 is attached to the arm 1200 via the torque hinge 1310 and is configured to be rotatable in the vertical and horizontal directions within a range of a pan angle θ2 of ±180 degrees and a tilt angle θ3 of ±45 degrees with respect to the state illustrated in FIG. 3 serving as 0 degrees.

Note that the external view illustrated in FIG. 3 is only exemplary and the appearance is not restricted thereto. The terminal 10 may be, for example, a general PC, a smart phone, a tablet terminal, an electronic black board, a projector, a car navigation apparatus mounted on a car, an image forming apparatus such as a multifunction peripheral or a printer, a wearable terminal, or the like. The camera 112 and the microphone 114 need not necessarily be built-in devices and may be external devices.

Since the PCs 20, the relay devices 30, the communication management system 50, the communication terminal management system 80, the program providing system 90, and the maintenance system 100 each have the same appearance as that of a general server computer, descriptions of the appearances thereof are omitted.

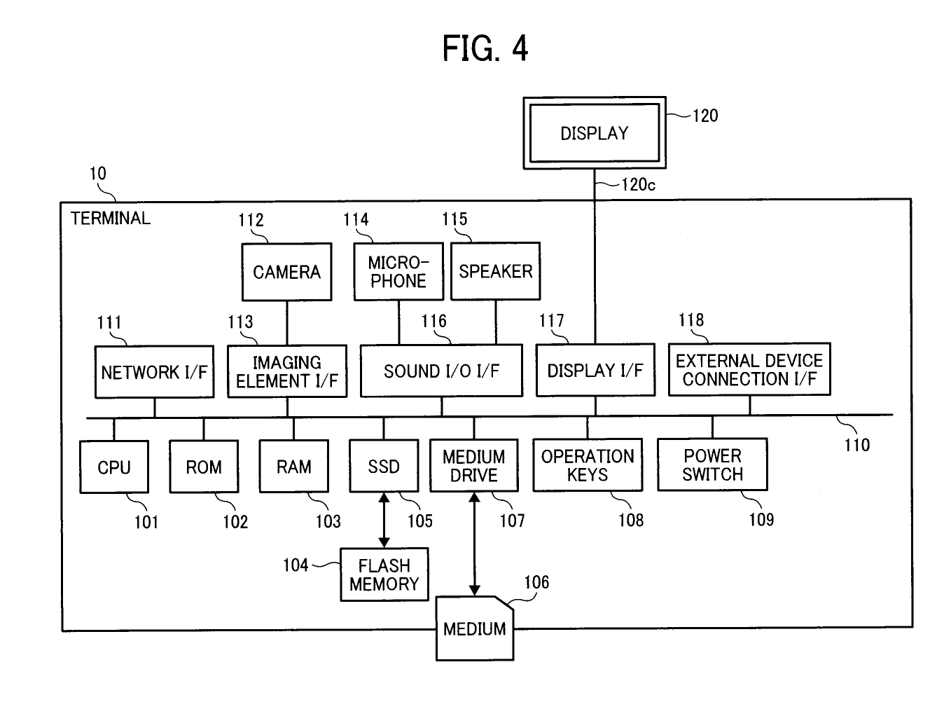

FIG. 4 is a hardware configuration diagram of a terminal 10 according to the embodiment of the present invention. As illustrated in FIG. 4, the terminal 10 includes a central processing unit (CPU) 101 that controls the overall operation of the terminal 10, a read-only memory (ROM) 102 that stores a program used for controlling the CPU 101, such as an initial program loader (IPL), a random-access memory (RAM) 103 used as a work area for the CPU 101, a flash memory 104 that stores various types of data, such as the terminal program, image data, and sound data, a solid state drive (SSD) 105 that controls reading/writing of various types of data from/to the flash memory 104 under control of the CPU 101, a medium drive 107 that controls reading/writing (storage) of data from/to a recording medium 106 such as a flash memory, the operation keys 108 operated in the case of, for example, selecting a counterpart terminal of the terminal 10, the power switch 109 for turning on/off the power of the terminal 10, and a network interface (I/F) 111 for performing data communication using the communication network 2.

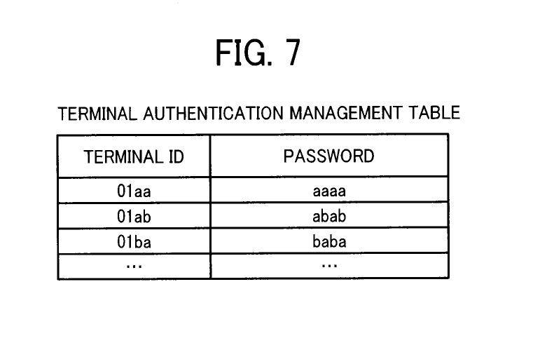

In addition, the terminal 10 includes the built-in camera 112, which captures an image of a subject and obtains image data under control of the CPU 101, an imaging element I/F 113 that controls driving of the camera 112, the built-in microphone 114, which receives a sound input, the built-in speaker 115, which outputs sound, a sound input/output I/F 116 that processes inputting/outputting of a sound signal between the microphone 114 and the speaker 115 under control of the CPU 101, a display I/F 117 that communicates image data to an external display 120 under control of the CPU 101, the external device connection I/F 118 connected to a connection port 1021g illustrated in FIG. 3 in order to connect various external devices, the alarm lamp 119, which indicates an abnormality of various functions of the transmission terminal 10, and a bus line 110 such as an address bus and a data bus for electrically connecting the above-described elements as illustrated in FIG. 7.

Each of the displays 120 displays an image of a subject, an icon for operation, or the like, and is a liquid crystal display (LCD), an organic electroluminescence (EL) display, or the like. In addition, the display 120 is connected to the display I/F 117 by the cable 120c.

The cable 120c may be an analog red green blue (RGB) (video graphic array (VGA)) signal cable, a component video cable, a high-definition multimedia interface (HDMI) signal cable, or a digital video interactive (DVI) signal cable.

The camera 112 includes a lens and a solid-state imaging element that converts an image (video) of a subject to electronic data by converting light to electric charge. As the solid-state imaging element, for example, a complementary metal-oxide-semiconductor (CMOS) or a charge-coupled device (CCD) is used.

The external device connection I/F 118 is capable of connecting an external device such as an external camera, an external microphone, or an external speaker by using a Universal Serial Bus (USB) cable or the like. In the case where an external camera is connected, the external camera is driven in preference to the built-in camera 112 under control of the CPU 101. Similarly, in the case where an external microphone is connected or an external speaker is connected, the external microphone or the external speaker is driven in preference to the built-in microphone 114 or the built-in speaker 115 under control of the CPU 101.

Note that the recording medium 106 is configured to be removable from the terminal 10. In addition, a non-volatile memory that reads or writes data under control of the CPU 101 is not limited to the flash memory 104, and an electrically erasable and programmable read-only memory (EEPROM) may be used instead.

Further, the terminal program may be recorded in a file in an installable format or an executable format on a computer-readable recording medium such as the recording medium 106 and distributed. In addition, the terminal program may be stored on the ROM 102, instead of the flash memory 104.

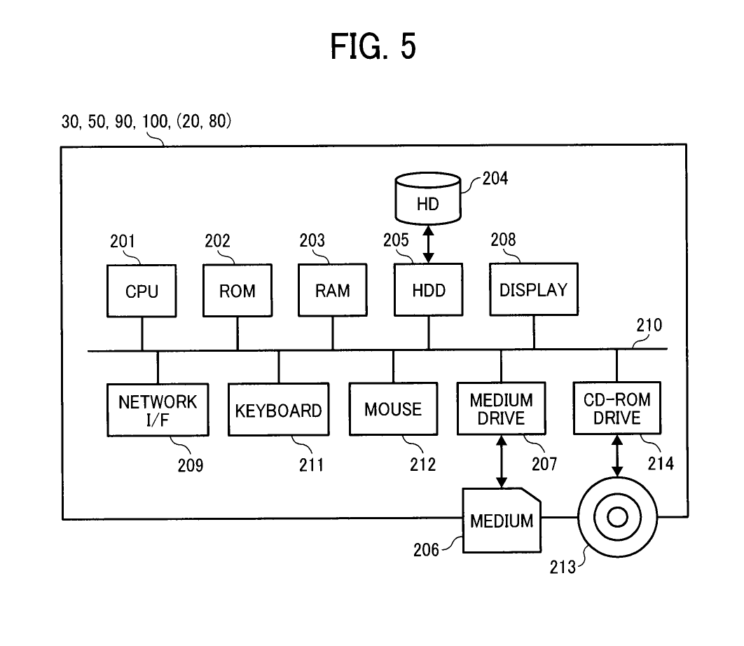

FIG. 5 is a hardware configuration diagram of the management system 50 according to the embodiment of the present invention. The communication management system 50 includes a CPU 201 that controls the overall operation of the communication management system 50, a ROM 202 that stores a program used for controlling the CPU 201, such as an IPL, a RAM 203 used as a work area for the CPU 201, an HD 204 that stores various types of data, such as the communication management program, a hard disk drive (HDD) 205 that controls reading/writing of various types of data from/to the HD 204 under control of the CPU 201, a medium drive 207 that controls reading/writing (storage) of data from/to a recording medium 206 such as a flash memory, a display 208 that displays various types of information such as a cursor, a menu, a window, characters, or an image, a network I/F 209 for communicating data using the communication network 2, a keyboard 211 including a plurality of keys for entering characters, numerals, and various instructions, a mouse 212 that selects and executes various instructions, selects a processing target, and moves the cursor, a compact disc read-only memory (CD-ROM) drive 214 that controls reading/writing of various types of data from/to a CD-ROM 213 serving as an example of a removable recording medium, and a bus line 210 such as an address bus and a data bus for electrically connecting the above-described elements as illustrated in FIG. 5.

Note that the communication management program may be recorded in a file in an installable format or an executable format on a computer-readable recording medium such as the recording medium 206 or the CD-ROM 213 and distributed. In addition, the communication management program may be stored on the ROM 202, instead of the HD 204.

In addition, since the relay devices 30 have a hardware configuration that is the same as or similar to that of the above-described communication management system 50, a description thereof is omitted. Note that the HD 204 stores a relay device program for controlling the relay devices 30. Also in this case, the relay device program may be recorded in a file in an installable format or an executable format on a computer-readable recording medium such as the recording medium 206 or the CD-ROM 213 and distributed. In addition, the relay device program may be stored on the ROM 202, instead of the HD 204.

In addition, since the program providing system 90 and the maintenance system 100 each have a hardware configuration that is the same as or similar to that of the above-described communication management system 50, descriptions thereof are omitted. Note that the HD 204 stores a program providing program for controlling the program providing system 90. Also in this case, the program providing program may be recorded in a file in an installable format or an executable format on a computer-readable recording medium such as the recording medium 206 or the CD-ROM 213 and distributed. In addition, the program providing program may be stored on the ROM 202, instead of the HD 204.

Note that each of the above-described programs may be recorded on a computer-readable recording medium such as a compact disc recordable (CD-R), a digital versatile disk (DVD), or a Blu-ray disk, which serve as other examples of the above-described removable recording medium, and may be provided.

Further, since the PCs 20 and the communication terminal management system 80 each have a hardware configuration that is the same as or similar to that of the above-described communication management system 50, descriptions thereof are omitted. Note that a web application program and data provided to each terminal 10 are recorded on the HD204 of the communication terminal management system 80.

### <Functional Configuration of Communication System>

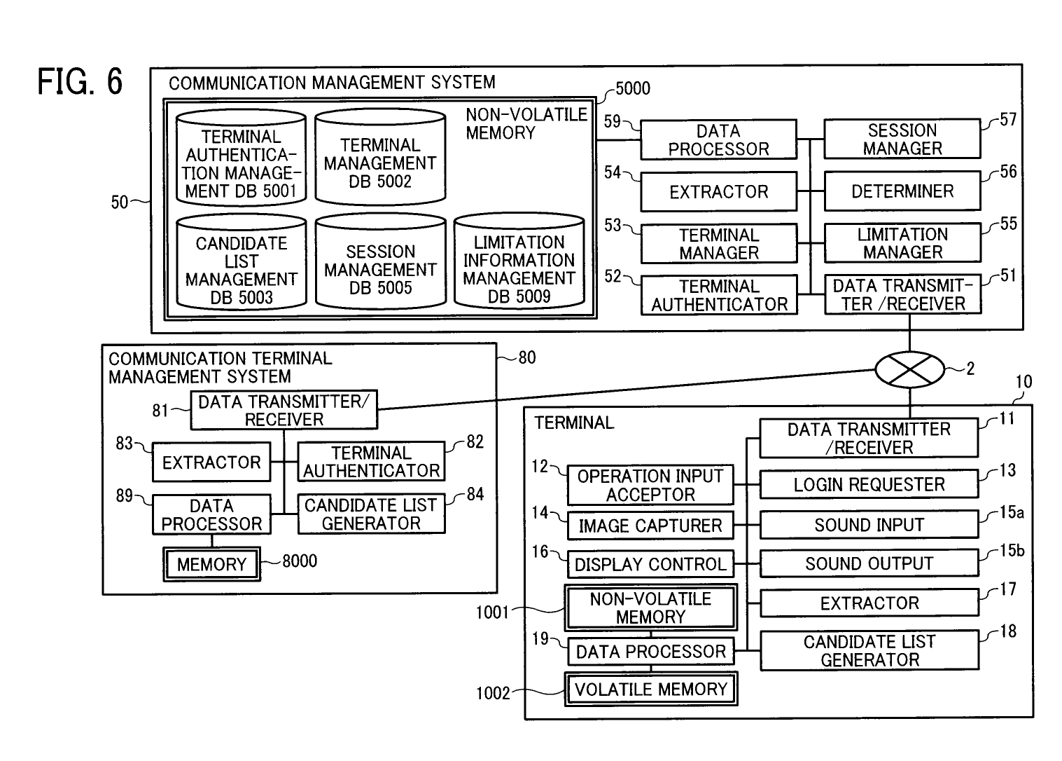

Next, the functional configuration of the embodiment will be described. FIG. 6 is a functional block diagram of a terminal 10, the communication terminal management system 80, and the communication management system 50 included in the communication system 1 of the embodiment. In FIG. 6, the terminal 10, the communication terminal management system 80, and the communication management system 50 are connected to be capable of communicating data via the communication network 2. In addition, since the program providing system 90 illustrated in FIG. 1 is not directly related to videoconference communication, the program providing system 90 is omitted in FIG. 6. Also, since the PCs 20 illustrated in FIG. 1 are general PCs, they are omitted in FIG. 6.

### <Functional Configuration of Terminal>

The terminal 10 includes a data transmitter/receiver 11, an operation input acceptor 12, a login requester 13, an image capturer 14, a sound input 15a, a sound output 15b, a display control 16, an extractor 17, a candidate list generator 18, and a data processor 19. These elements are functions that are realized by or elements that are caused to function by operating any of the elements illustrated in FIG. 4 in response to a command from the CPU 101 in accordance with a terminal control program expanded from the flash memory 104 to the RAM 103.

In addition, the terminal 10 includes a volatile memory 1002 including the RAM 103 illustrated in FIG. 4, and a non-volatile memory 1001 including the flash memory 104 illustrated in FIG. 4.

Next, using FIGS. 4 and 6, functional configuration of the terminal 10 will be described. Note that, in the following description of functional configuration of the terminal 10, among elements illustrated in FIG. 4, relationships with main elements for realizing the functional configuration of the terminal 10 will also be described.

The data transmitter/receiver 11 of the terminal 10 illustrated in FIG. 6 is realized by a command from the CPU 101 illustrated in FIG. 4 and by the network I/F 111 illustrated in FIG. 4, and performs transmission/reception of various types of data (or information) to/from another terminal, apparatus, or system via the communication network 2. Before starting communication with a desired counterpart terminal, the data transmitter/receiver 11 starts receiving, from the communication management system 50, operation state information indicating the operation state of each terminal 10 serving as a candidate counterpart terminal. The operation state information not only indicates the operation state of each terminal 10 (whether the terminal 10 is online or offline), but also indicates a detailed state such as whether the terminal 10 whose state is online is now communicating or the user of the terminal 10 is not at the terminal 10. In addition, the operation state information not only indicates the operation state of each terminal 10, but also indicates various states, such as the state that the cable 120c is disconnected from the terminal 10, the state that the terminal 10 can output sound but not images, or the state that the terminal 10 is muted.

The operation input acceptor 12 is realized by a command from the CPU 101 illustrated in FIG. 4 and by the operation keys 108 and the power switch 109 illustrated in FIG. 4, and accepts various inputs from the user. For example, when the user turns on the power switch 109 illustrated in FIG. 4, the operation input acceptor 12 illustrated in FIG. 6 accepts the power on operation and turns on the power.

The login requester 13 is realized by a command from the CPU 101 illustrated in FIG. 4, and, in response to acceptance of the above-described power on operation, automatically transmits, from the data transmitter/receiver 11 to the communication management system 50 via the communication network 2, login request information indicating a login request, and the current IP address of the request sender terminal. In addition, when the user turns the power switch 109 from on to off, the data transmitter/receiver 11 transmits to the communication management system 50 state information indicating that the power is to be turned off, and then the operation input acceptor 12 completely turns off the power. Accordingly, the communication management system 50 side can detect that the power of the terminal 10 is turned from on to off.

The image capturer 14 is realized by a command from the CPU 101 illustrated in FIG. 4 and by the camera 112 and the imaging element I/F 113 illustrated in FIG. 4. The image capturer 14 captures an image of a subject and outputs image data obtained by capturing the image.

The sound input 15a is realized by a command from the CPU 101 illustrated in FIG. 4 and by the sound input/output I/F 116 illustrated in FIG. 4. After the voice of the user is converted to a sound signal by the microphone 114, the sound input 15a receives sound data according to this sound signal. The sound output 15b is realized by a command from the CPU 101 illustrated in FIG. 4 and by the sound input/output I/F 116 illustrated in FIG. 4, and outputs the sound signal according to the sound data to the speaker 115, and the speaker 115 outputs sound.

The display control 16 is realized by a command from the CPU 101 illustrated in FIG. 4 and by the display I/F 117 illustrated in FIG. 4, and performs control for transmitting image data to the external display 120.

The extractor 17 is realized by a command from the CPU 101 illustrated in FIG. 4, and extracts various types of data (or information) from the volatile memory 1002.

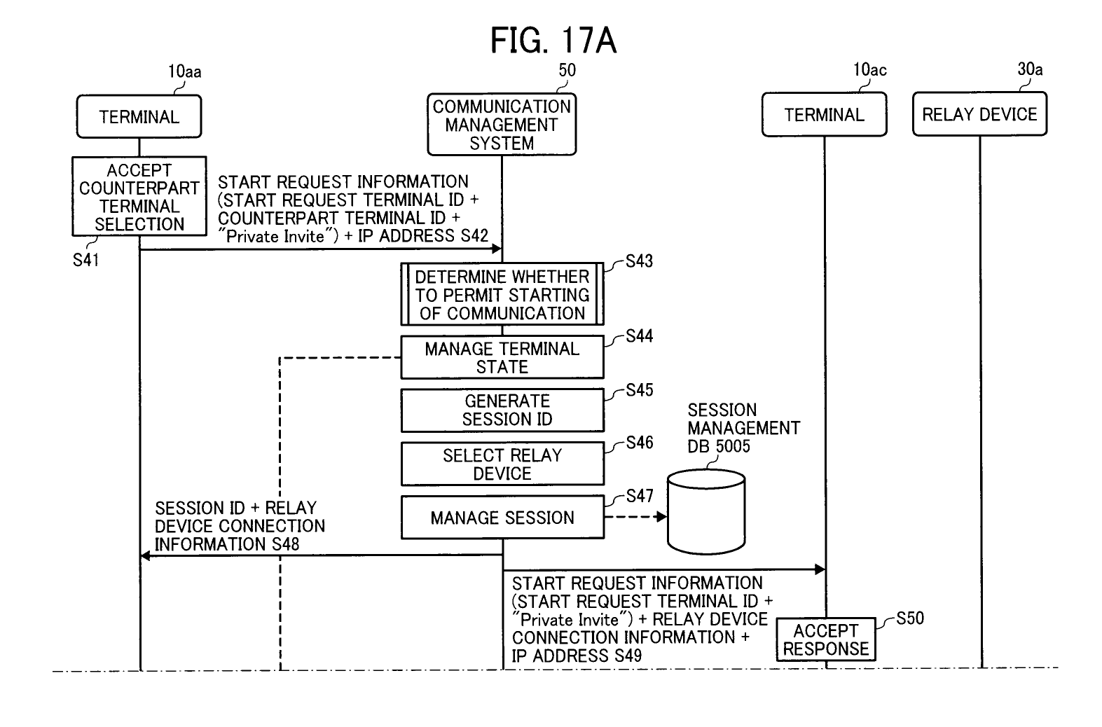

The candidate list generator 18 generates and updates a candidate list in which the state of a candidate counterpart terminal such as that illustrated in FIG. 16 is indicated by an icon, on the basis of later-described candidate list information and the state information of each terminal 10 serving as a candidate counterpart terminal, which are received from the communication management system 50.

In addition, the data processor 19 is executed by a command from the CPU 101 illustrated in FIG. 4 and by the SSD 105 illustrated in FIG. 4, and performs processing to store various types of data in the non-volatile memory 1001 or to read various types of data stored in the non-volatile memory 1001. The non-volatile memory 1001 stores a terminal identification (ID) serving as an example of identification information for identifying the terminal 10, a password, and the like. Further, the data processor 19 also performs processing to store various types of data in the volatile memory 1002 or to read various types of data stored in the volatile memory 1002. Every time image data and sound data are received in performing communication with a counterpart terminal, the volatile memory 1002 overwrites and stores the image data and sound data. On the basis of image data before being overwritten, an image is displayed on the display 120, and, on the basis of sound data before being overwritten, sound is output from the speaker 115.

Note that a terminal ID and a later-described relay device ID in the embodiment indicate identification information such as a language, a character(s), a symbol(s), or various marks used to uniquely identify a corresponding terminal 10 and a corresponding relay device 30. In addition, a terminal ID and a relay device ID may be identification information including a combination of at least two of the above-mentioned language, character(s), symbol(s), and various marks.

### <Functional Configuration of Communication Management System>

The communication management system 50 includes a data transmitter/receiver 51, a terminal authenticator 52, a terminal manager 53, an extractor 54, a limitation manager 55, a determiner 56, a session manager 57, and a data processor 59. These elements are functions that are realized by or elements that are caused to function by operating any of the elements illustrated in FIG. 5 in response to a command from the CPU 201 in accordance with a management system program expanded from the HD 204 to the RAM 203. In addition, the communication management system 50 includes a non-volatile memory 5000 in which various types of data (or information) is kept stored even when the power of the communication management system 50 is turned off, and the non-volatile memory 5000 is configured by the HD 204 illustrated in FIG. 5. In addition, the non-volatile memory 5000 stores candidate list frame data illustrated in FIG. 16 (which is data of a candidate list frame portion illustrated in FIG. 16, and which includes no icon indicating a specific operation state, no terminal ID, or no terminal name).

### (Terminal Authentication Management Table)

In the non-volatile memory 5000, a terminal authentication management DB 5001 configured by a terminal authentication management table such as that illustrated in FIG. 7 is stored. In the terminal authentication management table, a password is managed in association with each of terminal IDs of all terminals 10 managed by the communication management system 50. For example, the terminal authentication management table illustrated in FIG. 7 indicates that the terminal ID of the terminal 10aa is “01aa”, and the password of the terminal 10aa is “aaaa”,

### (Terminal Management Table)

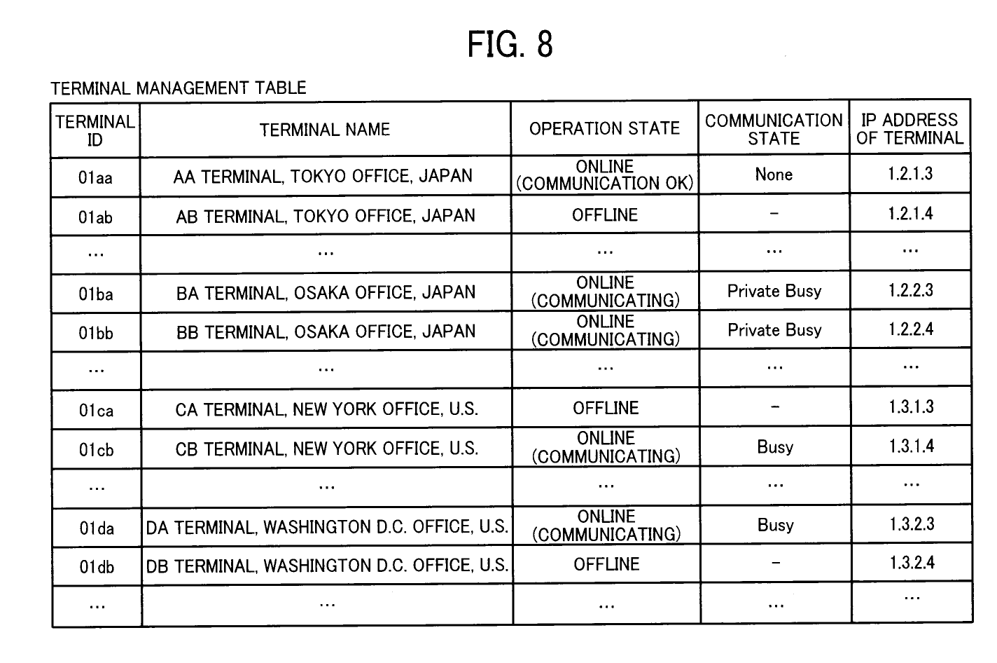

Also in the non-volatile memory 5000, a terminal management DB 5002 configured by a terminal management table such as that illustrated in FIG. 8 is stored. In the terminal management table, the counterpart terminal name of each terminal 10 in the case where the terminal 10 serves as a counterpart terminal, and the operation state, communication state, and IP address of the terminal 10 are managed in association with the terminal ID of the terminal 10. Here, the operation state is one of the following: online, which is a state where the power is turned on and the terminal 10 is capable of communicating or is currently communicating; and offline, which is a state where the terminal 10 is incapable of communicating since the power is turned off, for example.

In addition, the communication state is one of the following: “busy”, which indicates a state where the terminal 10 has established a session with another terminal 10 and is currently communicating content data in a videoconference; and “none”, which indicates a standby state where the terminal 10 is not communicating with another terminal 10. In the communication management system 50 of the embodiment, a communication state corresponding to a content data session sed that limits terminals 10 that can participate is managed as a communication state different from a communication state corresponding to a content data session sed where there is no participation limitation. That is, there is “private busy”, which is a communication state for a session where there is participation limitation, in contrast to “busy”, which is for a session where there is no participation limitation. Because the communication states are managed in distinction from one another in accordance with whether there is participation limitation, it is possible to identify in the communication management system 50 whether there is participation limitation in accordance with the communication state.

For example, the terminal management table illustrated in FIG. 8 indicates that the terminal 10aa whose terminal ID is “01aa” has the terminal name “AA terminal, Tokyo office, Japan”, the operation state “online (communication OK)”, the communication state “none”, and the IP address “1.2.1.3”.

### (Candidate List Management Table)

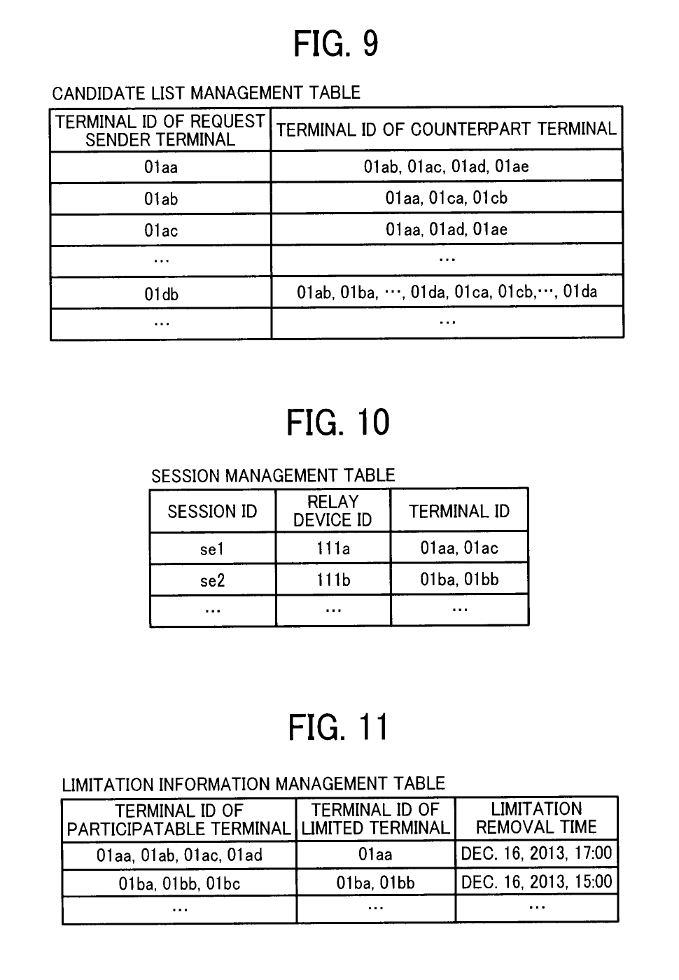

Further, in the non-volatile memory 5000, a candidate list management DB 5003 configured by a candidate list management table such as that illustrated in FIG. 9 is stored. In the candidate list management table, the terminal IDs of all terminals 10 registered as candidate counterpart terminals are managed in association with the terminal ID of a request sender terminal that can send a request to start communication in a videoconference. For example, the candidate list management table illustrated in FIG. 9 indicates that candidates for a counterpart terminal to which a request sender terminal (terminal 10aa) whose terminal ID is “01aa” can give a request to start communication in a videoconference are the terminal 10ab whose terminal ID is “01ab”, the terminal 10ac whose terminal ID is “01ac”, the terminal 10ad whose terminal ID is “01ad”, and so forth. The candidate counterpart terminals are updated by addition or deletion in response to an addition or deletion request from an arbitrary request sender terminal to the communication management system 50. Note that, in the candidate list management DB 5003 (see FIG. 9), not only the terminal ID of a counterpart terminal registered as a candidate for a counterpart terminal, but also a counterpart terminal name managed for each terminal ID in the terminal management table (see FIG. 8) may also be managed in association therewith.

### (Session Management Table)

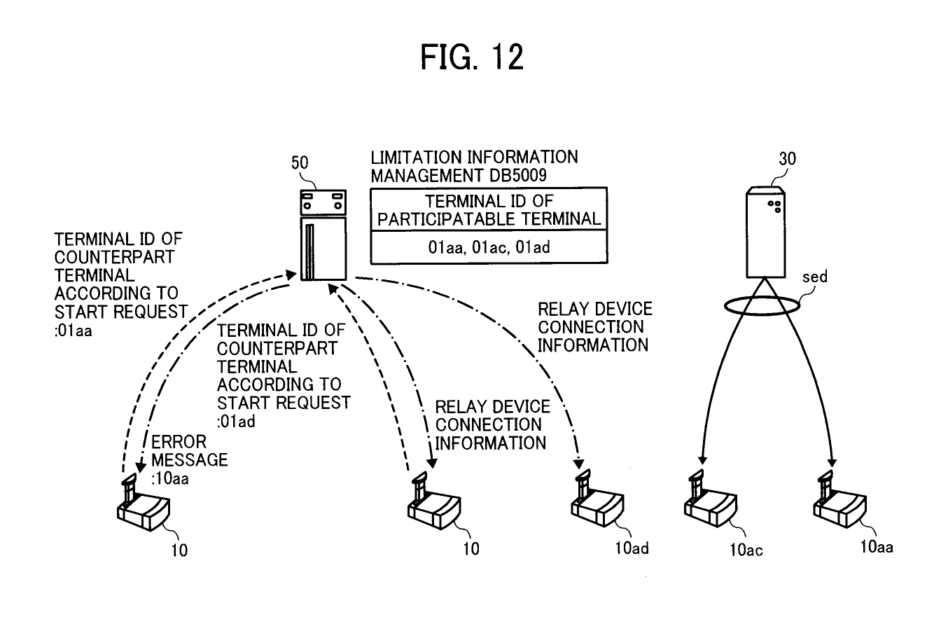

Also in the non-volatile memory 5000, a session management DB 5005 configured by a session management table such as that illustrated in FIG. 10 is stored. Note that FIG. 10 is an illustration of a session management table. In the session management table, in association with each session ID for identifying a content data session sed in which content data is transmitted between terminals 10, the relay device ID of a relay device 30 used in relaying the content data in this session, and the terminal IDs of terminals 10 participating in this session are managed. For example, the session management table illustrated in FIG. 10 indicates that, in a session identified by the session ID “se1”, a relay device 30 that relays content data is the relay device 30a whose relay device ID is “111a”, and the relay device 30a relays content data between a start request sender terminal (terminal 10aa) whose terminal ID is “01aa” and a counterpart terminal (terminal 10ac) whose terminal ID is “01ac”.

### (Limitation Information Management Table)

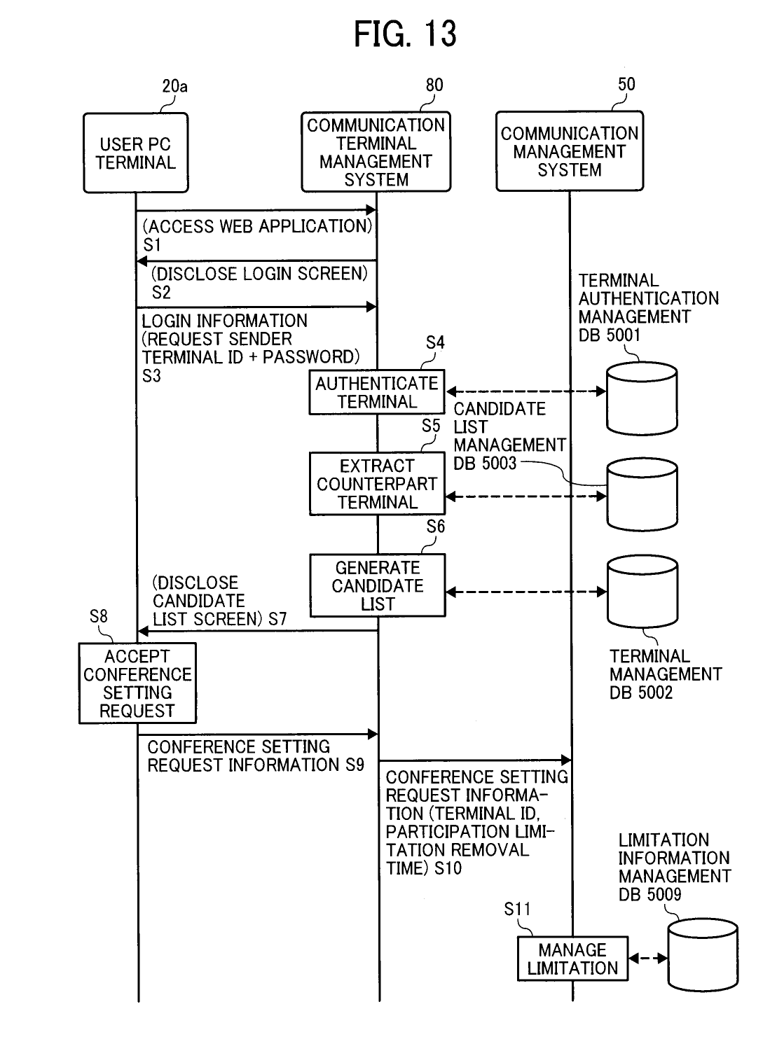

Further, in the non-volatile memory 5000, a limitation information management DB 5009 configured by a limitation information management table such as that illustrated in FIG. 11 is stored. In the limitation information management table, in association with each conference in which participatable terminals 10 are limited, the terminal ID of each terminal 10 that can participate in this conference (participatable terminal), the terminal ID of a terminal 10 whose communication partner is limited to a participatable terminal (limited terminal), and the time at which this limitation will be removed (limitation removal time) are managed. The limitation information management table illustrated in FIG. 11 indicates that the communication partners of the terminal 10aa whose terminal ID is “01aa” are limited to terminals (10ab, 10ac, and 10ad) whose terminal IDs are “01ab, 01ac, and 01ad” during a period until “Dec. 16, 2013, 17:00”.

Next, functional configuration of the communication management system 50 will be described in detail. Note that, in the following description of functional configuration of the communication management system 50, among elements illustrated in FIG. 5, relationships with main elements for realizing the functional configuration of the communication management system 50 will also be described.

The data transmitter/receiver 51 is executed by a command from the CPU 201 illustrated in FIG. 5 and by the network I/F 209 illustrated in FIG. 5, and performs transmission/reception of various types of data (or information) to/from another terminal, apparatus, or system via the communication network 2.

The terminal authenticator 52 is realized by a command from the CPU 201 illustrated in FIG. 5, and performs terminal authentication by searching the terminal authentication management DB 5001 in the non-volatile memory 5000 by using a terminal ID and a password included in login request information received via the data transmitter/receiver 51 as search keys and determining whether the same pair of a terminal ID and a password is managed in the terminal authentication management DB 5001.

The terminal manager 53 is realized by a command from the CPU 201 illustrated in FIG. 5. In order to manage the operation state of a request sender terminal that has given a login request, the terminal manager 53 stores and manages, in the terminal management DB 5002 (see FIG. 8), the terminal ID, the operation state, and the IP address of this request sender terminal in association with one another. In addition, on the basis of operation state information sent from the terminal 10 indicating that power is to be turned off when the user turns the power switch 109 of the terminal 10 from on to off, the terminal manager 53 changes the operation state indicating an online state to an offline state in the terminal management DB 5002 (see FIG. 8).

The extractor 54 is realized by a command from the CPU 201 illustrated in FIG. 5, searches the candidate list management DB 5003 (see FIG. 9) by using the terminal ID of a request sender terminal that has given a login request as a key, and reads the terminal ID of a candidate counterpart terminal that can communicate with the request sender terminal, thereby extracting the terminal ID. Further, the extractor 54 searches the candidate list management DB 5003 (see FIG. 9) by using the terminal ID of a request sender terminal that has given a login request as a key, and extracts the terminal ID of another request sender terminal that has the terminal ID of the former-mentioned request sender terminal registered as a candidate for a counterpart terminal. In addition, the extractor 54 searches the terminal management DB 5002 (see FIG. 8) by using the terminal ID of a candidate counterpart terminal extracted by the extractor 54 as a search key, and reads the operation state for each terminal ID extracted by the extractor 54. Accordingly, the extractor 54 can obtain the operation state of a candidate counterpart terminal that can communicate with a request sender terminal that has given a login request. The extractor 54 also searches the terminal management DB 5002 (see FIG. 8) by using the terminal ID extracted by the extractor 54 as a key, and extracts the operation state of a request sender terminal that has given a login request.

The limitation manager 55 is realized by a command from the CPU 201 illustrated in FIG. 5, and stores and manages, for each new record in the limitation information management DB 5009 (see FIG. 11), the terminal ID of a participatable terminal or a limited terminal, and the participation limitation removal time. For each record, the terminal ID of a participatable terminal or a limited terminal, and the participation limitation removal time are deleted.

The determiner 56 is realized by a command from the CPU 201 illustrated in FIG. 5, and, upon acceptance of a request from a terminal 10 for starting communication or for participating in a content data session sed, determines whether to permit starting of the requested communication.

The session manager 57 is realized by a command from the CPU 201 illustrated in FIG. 5, and generates a session ID for identifying a session in which content data is transmitted between terminals 10. In addition, the session manager 57 stores, in the session management table (see FIG. 10) in the non-volatile memory 5000, the session ID, the terminal ID of a request sender terminal, and the terminal ID of a counterpart terminal in association with one another. The session manager 57 also stores and manages, for each session ID in the session management table, the relay device ID of a relay device 30 that relays content data in this session.

The data processor 59 is executed by a command from the CPU 201 illustrated in FIG. 5 and the HDD 205 illustrated in FIG. 5, and performs processing to store various types of data in the non-volatile memory 5000 or read various types of data stored in the non-volatile memory 5000.

### <Functional Configuration of Communication Terminal Management System>

The communication terminal management system 80 includes a data transmitter/receiver 81, a terminal authenticator 82, an extractor 83, a candidate list generator 84, and a data processor 89. These elements are functions that are realized by or elements that are caused to function by operating any of the elements illustrated in FIG. 5 in response to a command from the CPU 201 in accordance with a communication terminal management system program expanded from the HD 204 to the RAM 203.

In addition, the communication terminal management system 80 includes a memory 8000 configured by the RAM 203 or the HD 204 illustrated in FIG. 5.

Next, functional configuration of the communication terminal management system 80 will be described in detail. Note that, in the following description of functional configuration of the communication terminal management system 80, among elements illustrated in FIG. 5, relationships with main elements for realizing the functional configuration of the communication terminal management system 80 will also be described.

The data transmitter/receiver 81 is executed by a command from the CPU 201 illustrated in FIG. 5 and by the network I/F 209 illustrated in FIG. 5, and performs transmission/reception of various types of data (or information) to/from another terminal, apparatus, or system via the communication network 2. The data transmitter/receiver 81 also has a web server function and a data processing function, which will be described later.

The terminal authenticator 82 is realized by a command from the CPU 201 illustrated in FIG. 5, accesses the communication management system 50 and searches the terminal authentication management DB 5001 (see FIG. 7) configured in the non-volatile memory 5000, thereby determining whether the same pair of a terminal ID and a password as that of the request sender terminal has been managed, and authenticating whether the terminal 10 of the user of the PC 20 is a legitimate terminal in this videoconference system.

The extractor 83 is realized by a command from the CPU 201 illustrated in FIG. 5, and searches the candidate list management DB 5003 (see FIG. 9) configured in the non-volatile memory 5000 of the communication management system 50 by using the terminal ID of the request sender terminal as a search key, thereby extracting the terminal ID of a corresponding counterpart terminal.

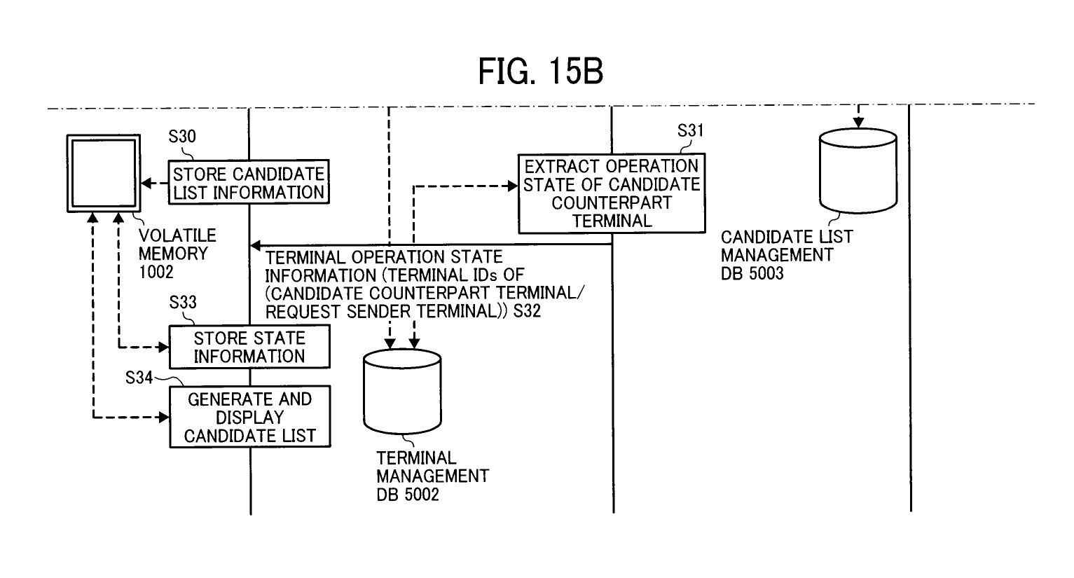

The candidate list generator 84 is realized by a command from the CPU 201 illustrated in FIG. 5, and generates the HyperText Markup Language (HTML) of a candidate list screen illustrated in FIG. 14.

The data processor 89 is executed by a command from the CPU 201 illustrated in FIG. 5 and the HDD 205 illustrated in FIG. 5, and performs processing to store various types of data in the memory 8000 or read various types of data stored in the memory 8000.

### <Process or Operation of Embodiment>

Next, a process or an operation of the embodiment will be described. First, using

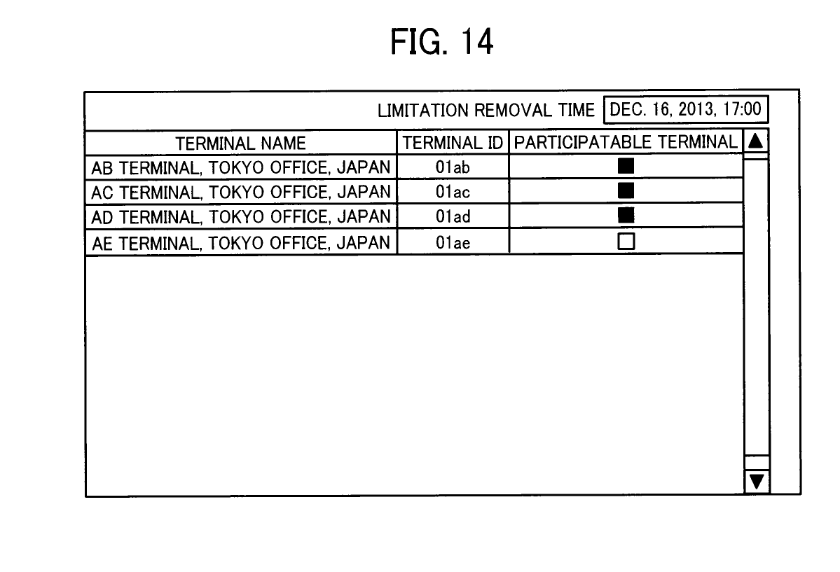

FIG. 12, the outline of an operation or a process of the embodiment will be described. FIG. 12 is an illustration of transmission/reception of various types of information in the communication system.

The limitation information management DB 5009 of the communication management system 50 stores, for a limited session where terminals 10 that can participate are limited, the terminal ID of each participatable terminal 10 (an example of participatable terminal identification information for identifying a participatable communication terminal). The data transmitter/receiver 51 receives a request for starting another session with a counterpart terminal, which is different from the above-mentioned limited session, from a request sender terminal. When the counterpart terminal of the request is one of the participatable terminals in the limited session, and is participating in the limited session or any other limited session, the determiner 56 determines to reject the request from the request sender terminal at least within a certain period.

When the counterpart terminal of the request is none of the participatable terminals in the limited session, or the participatable terminal not participating in the limited session or any other limited session, the determiner 56 determines to accept the request from the request sender communication terminal. In such case, the data transmitter/receiver 51 transmits connection information for a relay device 30 that relays content data in the session, to the request sender terminal and the counterpart terminal. Accordingly, when the terminal 10 is not participating in the limited session, the terminal 10 can participate in another session. In doing so, the terminal 10 can be effectively utilized.

The limitation information management DB 5009 stores a limitation removal time in the limited session, thereby managing, for each terminal 10 to participate in the limited session, a period in which the terminal 10 is supposed to participate in the limited session. According to the communication management system 50 of the embodiment, in the case where the counterpart terminal is not participating in the limited session even during a period in which the counterpart terminal is supposed to participate in the limited session, the request sender terminal is allowed to participate in another session.

In the case where an arbitrary terminal 10 participates in a limited session, the limitation information management DB 5009 of the communication management system 50 stores the terminal ID of this terminal 10 as the terminal ID of a limited terminal (an example of participant terminal identification information). Accordingly, whether the terminal is participating in the limited session can be identified. Therefore, the determiner 56 can determine, using the terminal ID of the limited terminal, whether to deny a request for starting another session.

After the above-mentioned certain period has elapsed, the limitation manager 55 of the communication management system 50 deletes, from the limitation information management DB 5009, the terminal ID of a limited terminal indicating the terminal 10 having been participated in the limited session, thereby updating the limitation information management DB 5009. Accordingly, the terminal 10, which had participated in the limited session, can participate in a new session.

The data transmitter/receiver 51 of the communication management system 50 transmits a list of participatable terminals as a candidate list to a limited terminal (an example of a communication terminal that can participate in a session), and, from the limited terminal to which the candidate list is transmitted, accepts a request for starting communication with a terminal 10 selected from the candidate list. This prevents the limited terminal from giving a request for starting a session other than the limited session.

In the embodiment, a PC 20 (an example of a second communication terminal) accepts selection of a participatable terminal on the basis of an operation of the keyboard 211 or the mouse 212. In addition, the limitation information management DB 5009 manages the terminal ID of the participatable terminal on the basis of the participatable terminal whose selection has been accepted by the PC 20. Accordingly, even in the case where a terminal 10 is not prepared with sufficient interface, registration of a participatable terminal can be easily accepted.

Next, a process or an operation of the embodiment will be described in detail. In some cases, a user is not used to perform operation or input with the operation keys 108 of a terminal 10, such that the user may prefer to operate a PC that the user is used to operate, instead of a terminal 10, to perform operation or input. In such case, the communication terminal management system 80 performs processing to convey various requests or the like from a PC 20 to the communication management system 50 by exchanging data or information with the PC 20.

Note that, in the embodiment, the communication terminal management system 80 is a web server and provides a web application for setting a conference. In the embodiment, the communication terminal management system 80 provides a function of limiting participation in a conference from a candidate list. A PC 20 can access the web application, provided by the communication terminal management system 80, through a web browser, and can perform operation for setting a conference. As long as being connectable to the Internet 2i, a PC 20 may be connected in any area. That is, the embodiment will discuss an example in which the user a of a request sender terminal (terminal 10aa) sets a conference from the PC 20a, in place of the terminal 10aa, via the communication terminal management system 80, and performs the conference via the terminal 10aa.

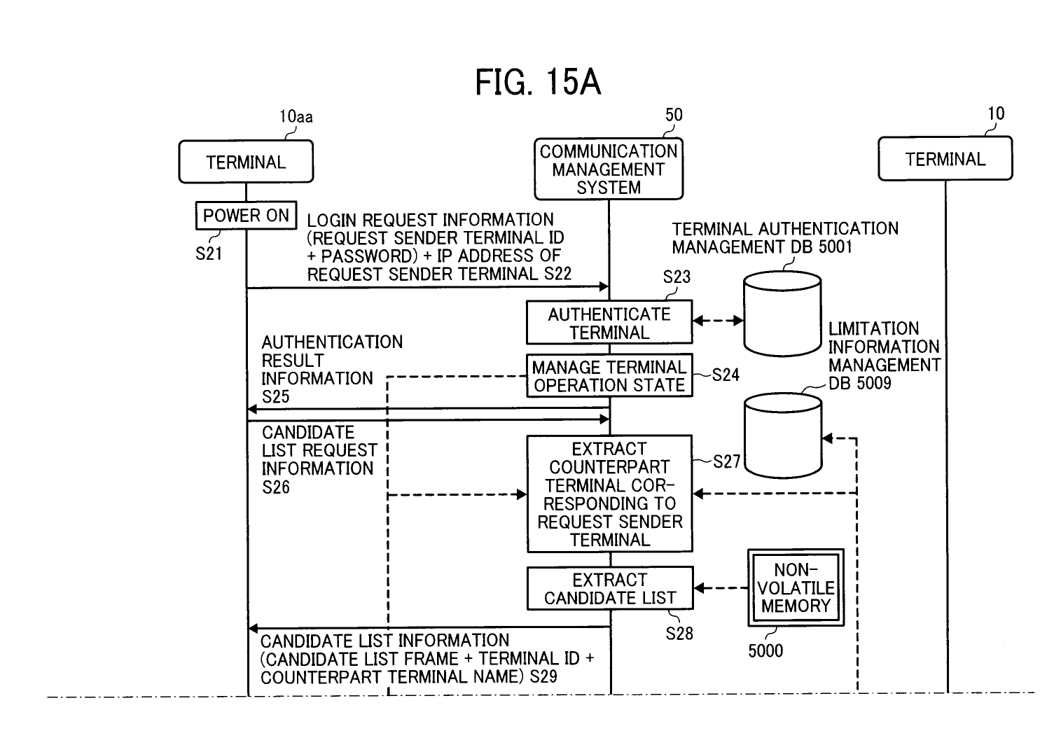

First, using FIG. 13, a process of selecting a terminal 10 that can participate in a conference will be described. Note that FIG. 13 is a sequence diagram illustrating a process of giving a conference setting request from a PC. FIG. 14 is an illustration of a candidate list.

As illustrated in FIG. 13, when the user a of the PC 20a inputs a uniform resource locator (URL) on a web browser of the PC 20a, the PC 20a accesses the web application provided by the communication terminal management system 80 (step S1). Accordingly, the web server function of the data transmitter/receiver 81 of the communication terminal management system 80 discloses a login screen to the PC 20a, thereby prompting the user a to input the terminal ID and the password of the request sender terminal (terminal 10aa) (step S2). When the user a inputs the terminal ID and the password of the request sender terminal (terminal 10aa) in response to this, the PC 20a transmits login information, which includes the terminal ID and the password of the request sender terminal, to the communication terminal management system 80 (step S3).

Next, the terminal authenticator 82 of the communication terminal management system 80 accesses the communication management system 50 and searches the terminal authentication management DB 5001 (see FIG. 7) configured in the non-volatile memory 5000, thereby determining whether the same pair of a terminal ID and a password as that of the request sender terminal has been managed, and authenticating whether the terminal 10aa of the user a of the PC 20a is a legitimate terminal in this communication system 1 (step S4). In the case where it is determined by this authentication that the terminal 10aa is a legitimate terminal, the extractor 83 continuously searches the candidate list management DB 5003 (see FIG. 9) configured in the non-volatile memory 5000 of the communication management system 50 on the basis of the terminal ID “01aa” of the request sender terminal, thereby extracting the terminal ID of a corresponding counterpart terminal (step S5).

Next, the candidate list generator 84 searches the terminal management DB 5002 (see FIG. 8) on the basis of the terminal ID extracted in step S5 described above, thereby extracting a corresponding terminal name, and then generates the HTML of a candidate list screen illustrated in FIG. 14 (step S6). The web server function of the data transmitter/receiver 81 discloses the candidate list screen to the PC 20a (step S7). The candidate list screen displays the counterpart terminal name and the terminal ID of a counterpart terminal, and an operation region for selecting a terminal 10 that can participate in a to-be-held conference (participatable terminal) or accepting an input of the time at which limitation of participatable terminals 10 will be removed (limitation removal time).

Next, when the user a operates the keyboard 211 or the mouse 212 of the PC 20a to select the check box of a participatable terminal on the candidate list screen and to input the limitation removal time, the PC 20a accepts a conference setting request (step S8). Accordingly, the PC 20a transmits conference setting request information to the communication terminal management system 80 (step S9). Accordingly, the data processing function of the data transmitter/receiver 81 of the communication terminal management system 80 analyzes the operation performed by the user a, and, in place of the terminal 10aa, transmits conference setting request information for the candidate list to the communication management system 50 (step S10). The conference setting request information includes the terminal ID of the selected participatable terminal, and the limitation removal time.

Upon reception of the conference setting request information by the data transmitter/receiver 51 of the communication management system 50, the limitation manager 55 manages the terminal ID of the participatable terminal, and the limitation removal time, which are included in the conference setting request information, in association with each other in the limitation information management table (see FIG. 11) (step S11). Further, the limitation manager 55 manages the terminal ID of the terminal 10aa, which is the conference setting request sender, as the terminal ID of a limited terminal in association with the above-mentioned terminal ID and limitation removal time in the limitation information management table. Note that the terminal ID of the participatable terminal, the terminal ID of the limited terminal, and the limitation removal time managed in the limitation information management table are deleted by the limitation manager 55 after the limitation removal time has come (step S11). Accordingly, a counterpart terminal 10 that can communicate with the terminal 10aa is limited to a participatable terminal from when the terminal 10aa is recorded as a limited terminal in the limitation information management table to the limitation removal time. Although the processing of performing the conference setting on the basis of a request from a PC 20 has been described above, the embodiment is not limited thereto. For example, upon a request from a terminal 10 for starting communication with another terminal 10, the former-mentioned terminal 10 may give a conference setting request to the communication terminal management system 80 or the communication management system 50, and may perform the conference setting by performing processing that is the same as steps S1 to S11 described above.

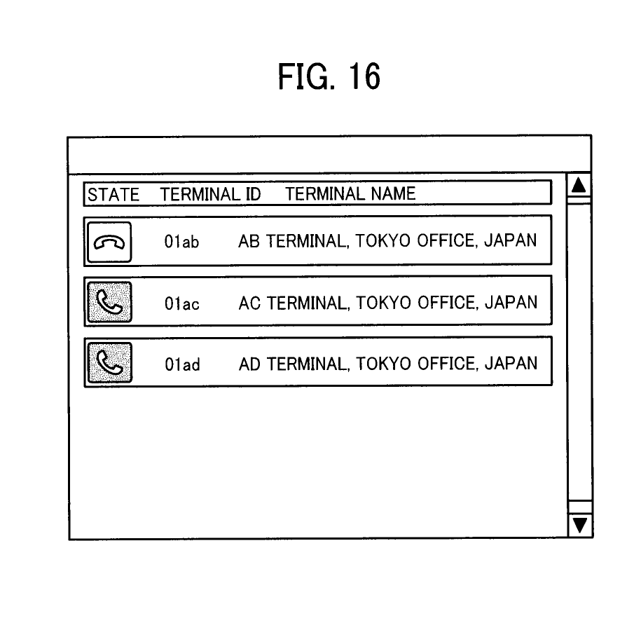

Next, a process of transmitting/receiving each item of management information at a preparation stage before the terminal 10aa starts a set conference will be described using FIGS. 15 and 16. FIG. 15 is a sequence diagram illustrating a process at a preparation stage for starting communication between communication terminals. FIG. 16 is an illustration of a candidate list. Note that, while performing operation of FIG. 15, various items of management information are transmitted or received entirely by a management information session sei.

First, when the user turns on the power switch 109 illustrated in FIG. 4, the operation input acceptor 12 illustrated in FIG. 6 accepts the power on operation and turns on the power (step S21). In response to acceptance of the power on operation, the login requester 13 automatically transmits login request information indicating a login request from the data transmitter/receiver 11 to the communication management system 50 via the communication network 2 (step S22). The login request information includes a terminal ID for identifying the terminal 10aa, which serves as a request sender, and a password. The terminal ID and the password are data that have been read via the data processor 19 from the non-volatile memory 1001 and sent to the data transmitter/receiver 11. In the case of transmitting login request information from the terminal 10aa to the communication management system 50, the communication management system 50, which is a receiving side, can detect the IP address of the terminal 10aa, which is a transmitting side.

Next, the terminal authenticator 52 of the communication management system 50 performs terminal authentication by searching the terminal authentication management DB 5001 (see FIG. 7) of the non-volatile memory 5000 by using the terminal ID and the password included in the login request information received via the data transmitter/receiver 51 as search keys, and determining whether the same terminal ID and the same password are managed in the terminal authentication management DB 5001 (step S23). In the case where the terminal authenticator 52 determines that the login request is a login request from a terminal 10 that has a legitimate use authority since the same terminal ID and the same password are managed, the terminal manager 53 stores, in the terminal management DB 5002 (see FIG. 8), for each record indicated by the terminal ID and counterpart terminal name of the terminal 10aa, the operation state, and the IP address of the terminal 10aa (step S24). Accordingly, the operation state “online” and the IP address “1.2.1.3” are managed in association with the terminal ID “01aa” in the terminal management table illustrated in FIG. 14.

The data transmitter/receiver 51 of the communication management system 50 transmits authentication result information indicating an authentication result obtained by the terminal authenticator 52 to the request sender terminal (terminal 10aa) which has given the above-mentioned login request, via the communication network 2 (step S25). In the embodiment, the case in which it has been determined by the terminal authenticator 52 that the terminal 10aa is a terminal that has a legitimate use authority will be described as follows.

In response to reception, by the request sender terminal (terminal 10aa), of the authentication result information indicating that the request sender terminal is a terminal that has a legitimate use authority, the data transmitter/receiver 11 transmits candidate list request information indicating a request for a candidate list to the communication management system 50 via the communication network 2 (step S26). Accordingly, the data transmitter/receiver 51 of the communication management system 50 receives the candidate list request information.

Next, the extractor 54 searches limited terminal IDs in the limitation information management table (see FIG. 11) by using the terminal ID “01aa” of the request sender terminal (terminal 10aa), which has given the login request, as a search key, and extracts the terminal ID of a participatable terminal as a candidate for a counterpart terminal that can communicate with the request sender terminal (terminal 10aa). At the same time, the extractor 54 reads and extracts a counterpart terminal name corresponding to this participatable terminal ID from the terminal management DB 5002 (see FIG. 8) (step S27). Note that, in the case where the terminal ID of the request sender terminal, which has given the login request, is not managed as a limited terminal ID in the limitation information management table, no limitation is placed on a counterpart terminal 10 that can communicate with this terminal 10. Thus, the extractor 54 searches the candidate list management DB 5003 (see FIG. 9) by using the terminal ID of the request sender terminal, which has given the login request, as a search key, and extracts the terminal ID of a candidate for a counterpart terminal that can communicate with the request sender terminal. At the same time, the extractor 54 reads and extracts a counterpart terminal name corresponding to this terminal ID from the terminal management DB 5002 (see FIG. 8). Here, the terminal IDs (“01ab”, “01ac”, and “01ad”) of participatable terminals (10ab, 10ac, and 10ad) corresponding to the terminal ID “01aa” of the request sender terminal (terminal 10aa), and terminal names (“AB terminal, Tokyo office, Japan”, “AC terminal, Tokyo office, Japan”, and “AD terminal, Tokyo office, Japan”) corresponding thereto are extracted.

Next, the data transmitter/receiver 51 of the communication management system 50 reads data of a candidate list frame from the memory 5000 via the data processor 59 (step S28), and transmits, to the request sender terminal (terminal 10aa), “candidate list information (candidate list frame, terminal IDs, and counterpart terminal names)” including this candidate list frame, and the terminal IDs and counterpart terminal names extracted by the extractor 54 (step S29). Accordingly, in the request sender terminal (terminal 10aa), the data transmitter/receiver 11 receives the candidate list information, and the data processor 19 stores the candidate list information in the volatile memory 1002 (step S30).

In this manner, in the embodiment, instead of managing candidate list information by each terminal 10, the communication management system 50 centrally manages candidate list information of all terminals 10. Therefore, even in the case where a new terminal 10 is included in the communication system 1, a terminal 10 of a new model is included in place of an already-included terminal 10, or the appearance of the candidate list frame is to be changed, the communication management system 50 centrally handles these cases, and hence, the burden of each terminal 10 changing candidate list information can be removed.

In addition, the extractor 54 of the communication management system 50 searches the terminal management DB 5002 (see FIG. 8) by using the terminal IDs (“01ab”, “01ac”, and “01ad”) of candidates for a counterpart terminal, which are extracted by the above-mentioned extractor 54, as search keys, and reads a corresponding operation state for each terminal ID extracted by the above-mentioned extractor 54, thereby obtaining the operation state of each of the terminals (10ab, 10ac, and 10ad) serving as candidate counterpart terminals (step S31).

Next, the data transmitter/receiver 51 transmits “terminal operation state information” including the terminal ID “01ab” serving as a search key used in step S31 described above and the operation state “offline” of a corresponding counterpart terminal (terminal 10ab) to the request sender terminal (terminal 10aa) via the communication network 2 (step S32). In addition, as part of step S32, the data transmitter/receiver 51 also separately transmits the remaining “terminal operation state information”, such as “terminal operation state information” including the terminal ID “01ac” and the operation state “online (communication OK)” of a corresponding counterpart terminal (terminal 10ac), to the request sender terminal (terminal 10aa).

Next, the data processor 19 of the request sender terminal (terminal 10aa) sequentially stores the terminal state information, received from the communication management system 50, in the volatile memory 1002 (step S33). Thus, by receiving the above-described state information of each terminal 10, the request sender terminal (terminal 10aa) can obtain the current operation state of each candidate for a counterpart terminal, such as a terminal 10 that can communicate with the request sender terminal (terminal 10aa).

Next, the candidate list generator 18 of the request sender terminal (terminal 10aa) generates a candidate list in which the state of a terminal 10 serving as a candidate counterpart terminal is reflected, on the basis of the candidate list information and the terminal state information stored in the volatile memory 1002, and controls the timing at which the display control 16 displays the candidate list on the display 120 illustrated in FIG. 4 (step S34). Note that, in the candidate list illustrated in FIG. 16, an icon indicating the operation state of each terminal 10 indicates the following from top: “offline”, “online (communication OK)”, and “online (communication OK)”.

According to the candidate list management table illustrated in FIG. 9, the terminal 10ae is included as a terminal 10 serving as a candidate counterpart terminal that can communicate with the request sender terminal (terminal 10aa). However, because the limitation information management table illustrated in FIG. 11 indicates that counterpart terminals 10 that can communicate with the terminal 10aa in a period until the limitation removal time “Dec. 16, 2013, 17:00” are limited to the participatable terminals (terminals (10ab, 10ac, and 10ad)), the terminal 10ae will not be included in the candidate list as a result of the processing in step S27 (see FIG. 16). Note that, after “Dec. 16, 2013, 17:00”, the limitation manager 55 deletes the limitation removal time “Dec. 16, 2013, 17:00”, and the terminal IDs of the participatable terminals and the limited terminal, which are associated with the limitation removal time, in the limitation information management table (see FIG. 11) (step S11). Accordingly, the terminal 10ae will be included in a candidate list generated after the limitation removal time. Therefore, the terminal 10aa can give a request for starting communication with the terminal 10ae.

Note that the candidate list illustrated in FIG. 16 is only exemplary, and the candidate list is not limited to this form. For example, in the candidate list management table, after all the terminals 10 registered as candidate counterpart terminals of the terminal 10aa are displayed, a message indicating that the terminal 10ae is unselectable may be displayed, on the basis of the terminal IDs of participatable terminals managed in the limitation information management table (see FIG. 11).

In contrast, when the user of another terminal 10 turns on the power switch 109 illustrated in FIG. 5, as in step S21 described above, the operation input acceptor 12 illustrated in FIG. 6 accepts the power on operation, and performs processing that is the same as steps S22 to S37 described above, a description of which will be omitted.

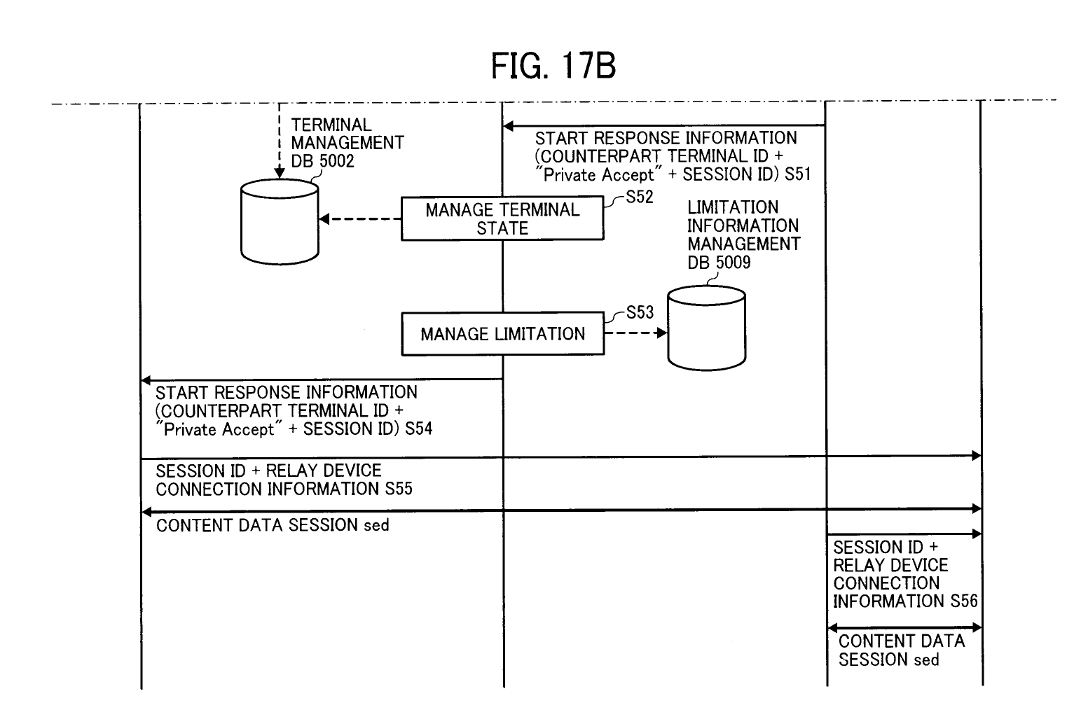

Next, a process in the case where the terminal 10aa gives a request for starting communication with another terminal 10 will be described using FIG. 17. FIG. 17 is a sequence diagram illustrating a process of giving a request for starting communication. Note that, while performing operation of FIG. 17, various items of management information are transmitted or received entirely by a management information session sei.

Referring to FIG. 17, an example in which the terminal 10aa operates as a start request sender terminal will be described. The terminal 10aa serving as a start request sender terminal can communicate with at least one of terminals, among candidate counterpart terminals, whose operation states are “online” and whose communication states are “none”, on the basis of the state information of the candidate counterpart terminals, received in step S32 described using FIG. 15. Here, the following description will discuss the case in which the user of a start request sender terminal (terminal 10aa) selects, from the candidate list, to start communication with a counterpart terminal (terminal 10ac).

Note that, in a state before the process illustrated in FIG. 17 starts, the display 120aa of the terminal 10aa serving as the start request sender terminal displays the candidate list illustrated in FIG. 16. The user of the start request sender terminal can select a desired communication partner, that is, a session partner, from the candidate list.

In the process illustrated in FIG. 17, first, when the user of the start request sender terminal presses the operation keys 108 illustrated in FIG. 4 and selects a counterpart terminal (terminal 10ac), a counterpart terminal selecting process is performed (step S41). Next, the data transmitter/receiver 11 of the terminal 10aa transmits start request information including the terminal ID “10aa” of the start request sender terminal (terminal 10aa), the terminal ID “10ac” of the counterpart terminal (terminal 10ac), and “private invite” indicating a request for starting communication where participatable terminals are limited, along with the IP address of the start request sender terminal, to the communication management system 50 (step S42). Accordingly, the data transmitter/receiver 51 of the communication management system 50 receives the above-mentioned start request information, and obtains the IP address “1.2.1.3” of the start request sender terminal (terminal 10aa), which is the transmission source.

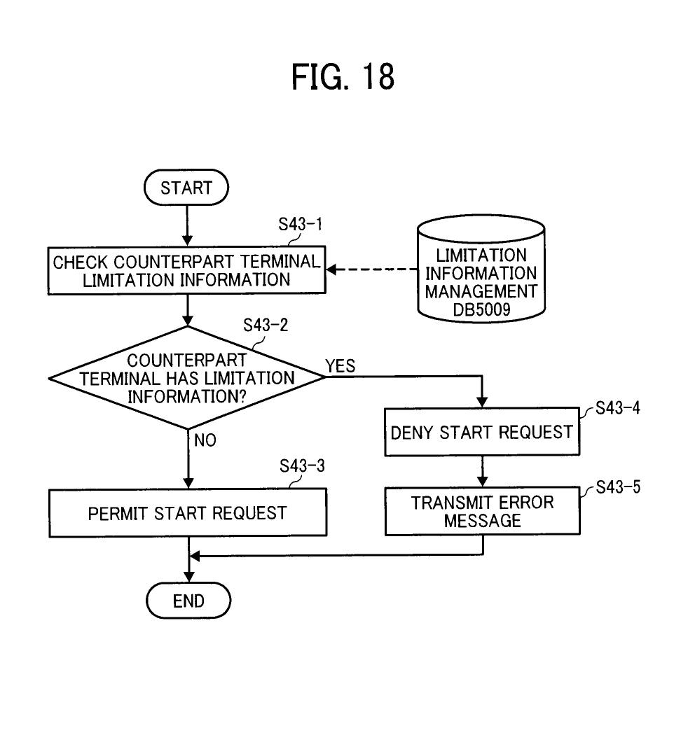

Upon acceptance of the start request information by the data transmitter/receiver 51 of the communication management system 50, the determiner 56 determines whether to permit the request for starting communication (step S43). The processing in step S43 will be described using FIG. 18. FIG. 18 is a flowchart illustrating a process of determining whether to permit the request for starting communication.

First, the data processor 59 refers to each record in the limitation information management table (see FIG. 11) except for a record according to a content data session sed that is to be started by the terminal 10aa, and checks whether the terminal ID “01ac” of the counterpart terminal (terminal 10ac) has been registered as the terminal ID of a limited terminal (step S43-1).

In the case where the terminal ID “01ac” of the counterpart terminal (terminal 10ac) has not been registered as the terminal ID of a limited terminal (NO in step S43-2), the determiner 56 permits the request for starting communication (step S43-3). This is because the counterpart terminal (terminal 10ac) has not been registered as a participatable terminal in another session different from the content data session sed requested to be started, or, even when the counterpart terminal (terminal 10ac) has been registered as a participatable terminal, the counterpart terminal (terminal 10ac) is not participating in the session.

In the case where the terminal ID “01ac” of the counterpart terminal (terminal 10ac) has been registered as the terminal ID of a limited terminal (YES in step S43-2), the determiner 56 denies the request for starting communication (step S43-4). This is because the counterpart terminal (terminal 10ac) is currently participating in another session different from the content data session sed requested to be started. In the case of the determination denying the request for starting communication, the data transmitter/receiver 51 transmits an error message to the start request sender terminal (terminal 10aa), and the process ends (step S43-5) to return to operation of FIG. 17.

Hereinafter, the case where the request for starting communication is permitted in step S43-3 will be described. In the terminal management table in the terminal management DB 5002 (see FIG. 8), the terminal manager 53 changes the communication state field of a record including the above-described terminal ID “10aa” to “private busy” on the basis of the terminal ID “10aa” of the start request sender terminal (terminal 10aa) included in the start request information (step S44).

Next, the session manager 57 generates the session ID “se1” for identifying a session (content data session sed) for executing communication with the counterpart terminal requested by the start request sender terminal (terminal 10aa) (step S45). When the session ID is generated, the session manager 57 stores the session ID “se1” in the non-volatile memory 5000.

Next, the session manager 57 of the communication management system 50 selects the relay device 30a as a relay device 30 for relaying content data in the content data session sed between the start request sender terminal (terminal 10aa) and the counterpart terminal (terminal 10ac) by using any desired known method (step S46).

When the processing of selecting the relay device 30 is completed, the session manager 57 stores and manages the relay device ID “111a” of the selected relay device 30a, the terminal ID “10aa” of the start request sender terminal (terminal 10aa), and the terminal ID “10ac” of the counterpart terminal (terminal 10ac) in the fields of the relay device ID, the terminal ID of the start request sender terminal, and the terminal ID of the counterpart terminal of a record including the session ID “se1” in the session management table (see FIG. 10) in the non-volatile memory 5000 (step S47).

Next, the data transmitter/receiver 51 transmits the session ID generated by the session manager 57, and relay device connection information used for connecting to the relay device 30a selected in step S46, to the start request sender terminal (terminal 10aa) via the communication network 2 (step S48). The relay device connection information may include the IP address “1.2.1.2”, authentication information, port number, and the like of the relay device 30a. Accordingly, the terminal 10aa can have the relay device connection information used for connecting to the relay device 30a used in relaying content data in execution of the session with the session ID “se1”.

Next, the data transmitter/receiver 51 transmits the terminal ID “10aa” of the start request sender terminal (terminal 10aa), the start request information “private invite” including the session ID “se1”, the above-mentioned relay device connection information used for connecting to the relay device 30a, and the IP address of the communication management system 50 to the counterpart terminal (terminal 10ac) (step S49). Accordingly, the data transmitter/receiver 11 of the counterpart terminal (terminal 10ac) receives the above-mentioned start request information, and obtains the relay device connection information used for connecting to the relay device 30a used in relaying content data, and the IP address “1.2.1.2” of the communication management system 50, which is the transmission source.

Next, in response to operation of the operation keys 108 of the counterpart terminal (terminal 10ac) by the user of the counterpart terminal, the operation input acceptor 12 accepts a response indicating permission for starting communication (session establishment) with the start request sender terminal (terminal 10aa) (step S50). Next, the data transmitter/receiver 11 of the counterpart terminal (terminal 10ac) transmits the terminal ID “10ac” of the counterpart terminal (terminal 10ac), the terminal ID “10aa” of the start request sender terminal (terminal 10aa), the information “private accept” indicating permission for establishment of a participation-limited session, and start response information including the session ID “se1” to the communication management system 50 (step S51).

In response to reception of the start response information by the data transmitter/receiver 51 of the communication management system 50, the terminal manager 53 changes the communication state field of each record including the above-mentioned terminal ID “10ac” to “private busy” in the terminal management table (see FIG. 8) on the basis of the terminal ID “10aa” of the request sender terminal (terminal 10aa) and the terminal ID “10ac” of the counterpart terminal (terminal 10ac) (step S52).

Next, the limitation manager 55 adds and records the terminal ID “01ac” of the counterpart terminal (terminal 10ac) in an area where the terminal ID “01aa” of the request sender terminal (terminal 10aa) is recorded as the terminal ID of a limited terminal in the limitation information management table (see FIG. 11) (step S53). Accordingly, counterpart terminals 10 that can communicate with the terminal 10ac are limited to participatable terminals (terminals (10aa, 10ab, and 10ad)) until the limitation removal time.

Next, the data transmitter/receiver 51 transmits the terminal ID “10ac” of the counterpart terminal (terminal 10ac), the information “private accept” indicating permission for the request for starting communication with the counterpart terminal, and the start response information including the session ID “se1” to the start request sender terminal (terminal 10aa) (step S54). In response to reception of the start request information, the start request sender terminal (terminal 10aa) connects to the relay device 30a by transmitting from the data transmitter/receiver 11 the session ID “se1”, and the relay device connection information obtained in step S48 to the relay device 30a (step S55). Similarly, the counterpart terminal (terminal 10ac) connects to the relay device 30a by transmitting from the data transmitter/receiver 11 the session ID “se1”, and the relay device connection information obtained in step S49 to the relay device 30a (step S56). Accordingly, the content data session sed for transmitting content data via the relay device 30a is established between the request sender terminal (terminal 10aa) and the counterpart terminal (terminal 10ac) via the relay device 30a, and a videoconference can be started.

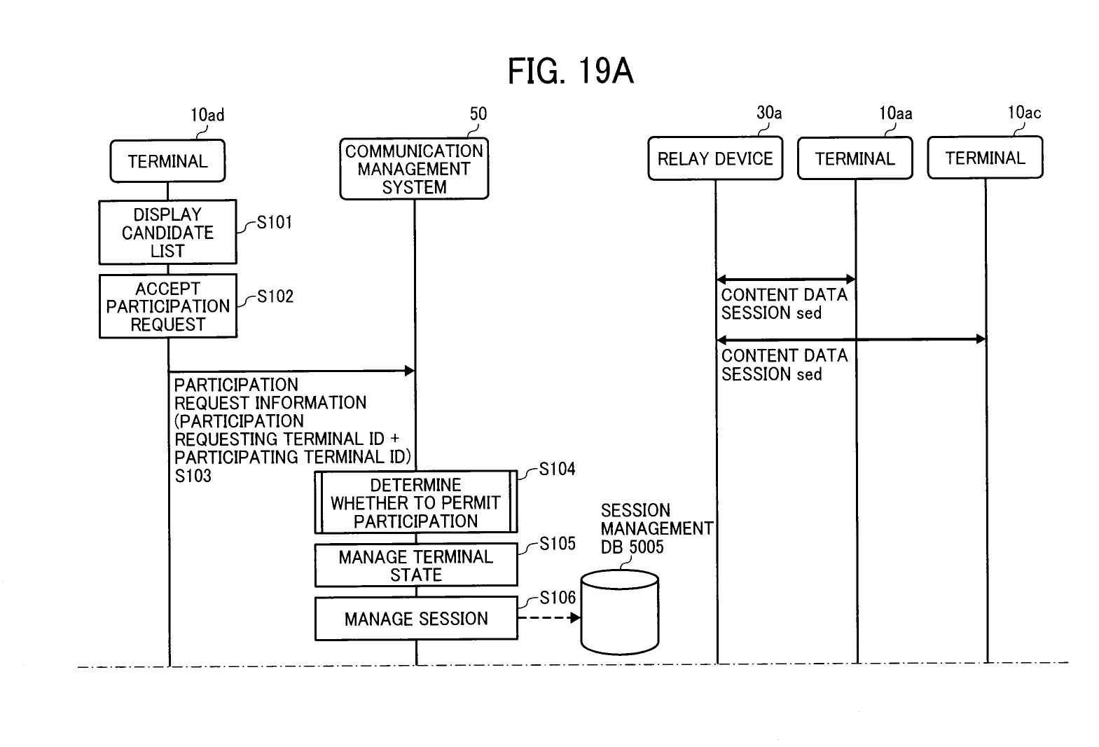

Next, using FIG. 19, a process of giving, after a content data session has been established between the start request sender terminal (terminal 10aa) and the counterpart terminal (terminal 10ac), a request from the terminal 10ad for participating in this content data session will be described. FIG. 19 is a data sequence diagram illustrating a process for the terminal 10ad to participate in the content data session. That is, the terminal 10ad operates as a participation requesting terminal that transmits participation request information. Note that, while performing operation of FIG. 19, various items of management information are transmitted or received entirely by a management information session sei.

First, the participation requesting terminal (terminal 10ad) performs processing that is the same as steps S21 to S34 of FIG. 15 in response to user operation, thereby displaying a candidate list on the display 120ad of the terminal 10ad (step S101).

The user of the participation requesting terminal (terminal 10ad) operates the operation keys 108 illustrated in FIG. 4 to select from the candidate list a terminal (hereinafter a “participating terminal”) that is already participating in a session that the user wants to participate in. In response to this, the operation input acceptor 12 accepts a request for participation in the already-established content data session (step S102). Hereinafter, the case in which the terminal 10aa is selected as a participating terminal will be described.

Accordingly, the data transmitter/receiver 11 of the participation requesting terminal (terminal 10ad) transmits participation request information including the terminal ID “01ad” of the participation requesting terminal (terminal 10ad) and the terminal ID “01aa” of the participating terminal, and indicating a request for participation in the content data session sed, to the communication management system 50 (step S103).

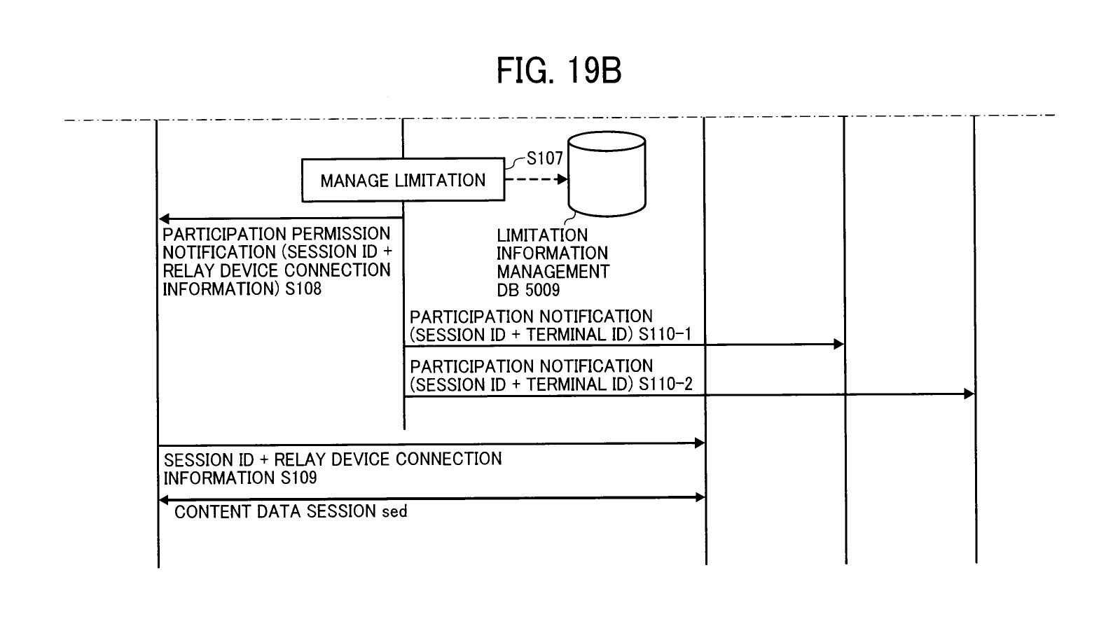

In response to reception of the session participation request information by the communication management system 50, the communication management system 50 determines whether to continue a process for connecting the participation requesting terminal (terminal 10ad) and participating terminals (terminals 10aa and 10ac) that are participating in the content data session sed (step S104). Here, the processing in step S104 will be described in more detail using FIG. 20. FIG. 20 is a flowchart illustrating a participation determination process.

First, the terminal manager 53 refers to the terminal management table (FIG. 8) and, by using the terminal ID “01aa” of the selected participating terminal (terminal 10aa), which is displayed in the participation request information, obtains the communication state of the participating terminal (terminal 10aa) (step S104-1). Next, the determiner 56 refers to the obtained communication state. In the case where the obtained communication state is “busy” (Busy in step S104-2), the determiner 56 permits the participation requesting terminal to participate in the already-established session (step S104-3). This is because the content data session in which the participating terminal is participating is not a session where participatable terminals are limited.

In contrast, in the case where the obtained communication state is “private busy” (Private Busy in step S104-2), the extractor 54 refers to a record in the limitation information management table (see FIG. 11) where the terminal ID “01aa” of the participating terminal (terminal 10aa) is recorded as the terminal ID of a limited terminal, and extracts the terminal ID(s) of a corresponding participatable terminal(s) (step S104-4).

In the case where the terminal ID “01ad” of the participation requesting terminal (terminal 10ad) is included in the terminal ID(s) of a participatable terminal(s), extracted in step S104-4 (YES in step S104-5), the determiner 56 permits the participation requesting terminal to participate in the already-established session (step S104-6).

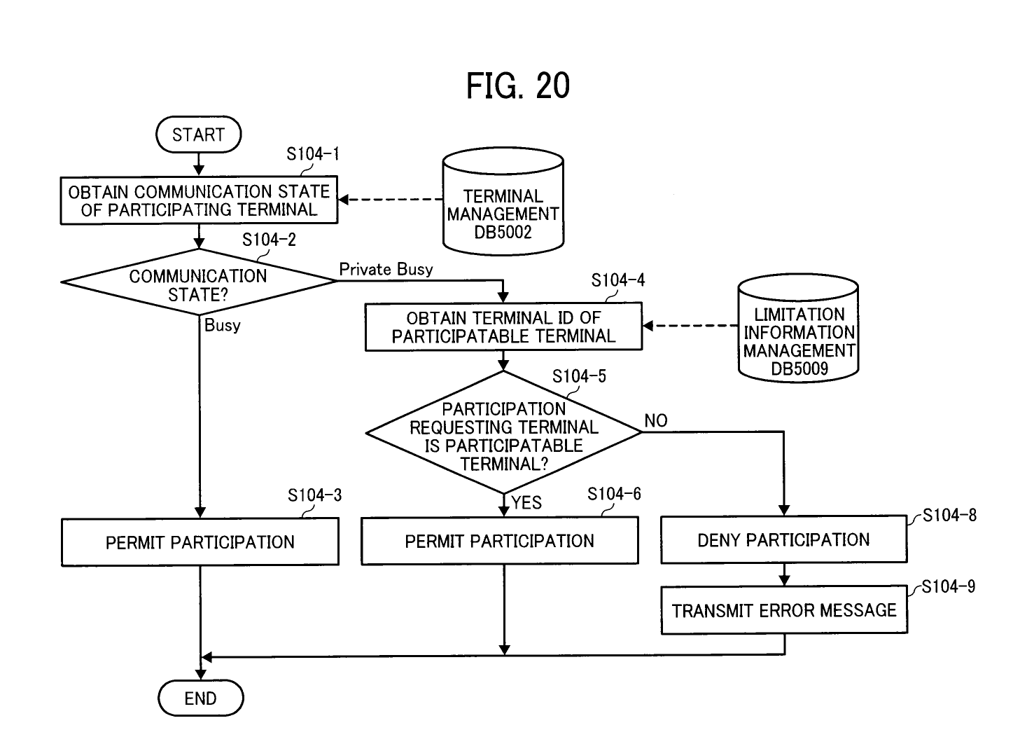

In contrast, in the case where the terminal ID “01ad” of the participation requesting terminal (terminal 10ad) is not included in the terminal ID(s) of a participatable terminal(s), extracted in step S104-4 (NO in step S104-5), the determiner 56 denies the participation requesting terminal to participate in the already-established session (step S104-8). In this case, the data transmitter/receiver 51 transmits an error message indicating that participation in the session is not allowed to the participation requesting terminal (terminal 10ad) (step S104-9). In response to reception of the error message by the participation requesting terminal (terminal 10ad), the participation requesting terminal (terminal 10ad) displays the error message on the display 120ad. Note that FIG. 21 is an illustration of an example of the error message displayed on the display 120ad.

Next, referring back to FIG. 19, regarding the case in which participation of the participation requesting terminal (terminal 10ad) in the already-established session is permitted and a process for connecting the participation requesting terminal and the participating terminals (terminals (10aa and 10ac)) is continued, a process thereafter will be described. In the terminal management table (see FIG. 6), the terminal manager 53 of the communication management system 50 changes the communication state field of a record including the above-described terminal ID “10ad” to “Private busy” on the basis of the terminal ID “10ad” of the participation requesting terminal (terminal 10ad) included in the participation request information (step S105).

Next, the session manager 57 adds the terminal ID “10ad” of the participation requesting terminal (terminal 10ad) to the counterpart terminal field of a record including the session ID “se1” in the session management table (see FIG. 10) in the non-volatile memory 5000 (step S106).

In addition, the limitation manager 55 adds and records the terminal ID “01ad” of the participation requesting terminal (terminal 10ad) in an area where the terminal IDs “01aa and 10ac” of the participating terminals (terminals (10aa and 10ac)) are recorded as the terminal IDs of, limited terminals in the limitation information management table (see FIG. 11) (step S107). Accordingly, counterpart terminals 10 that can communicate with the terminal 10ad are limited to the participatable terminals (10aa, 10ab, and 10ac) until the limitation removal time.

Next, the data transmitter/receiver 51 of the communication management system 50 transmits to the participation requesting terminal (terminal 10ad) the session ID “se1” and a participation permission notification including relay device connection information used for connecting to the relay device 30a (step S108).

In response to reception of the participation permission notification by the participation requesting terminal (terminal 10ad), the participation requesting terminal (terminal 10ad) connects to the relay device 30a by transmitting from the data transmitter/receiver 11 the session ID “se1”, and the relay device connection information included in the participation permission notification to the relay device 30a (step S109). Accordingly, a content data session sed is established between the terminal 10ad and the relay device 30a. In response to establishment of the content data session sed, the relay device 30a can relay image data and sound data among the terminals (10aa, 10ac, and 10ad). Accordingly, the terminals (10aa, 10ac, and 10ad) can start a videoconference.

In addition, the data transmitter/receiver 51 of the communication management system 50 transmits a participation notification including the terminal ID “01ad” of the participation requesting terminal (terminal 10ad) and the session ID “se1” to participating terminals (terminal 10aa and terminal 10ac) that have already started the content data session sed (steps S110-1 and S110-2). Accordingly, the participating terminals (terminal 10aa and terminal 10ac) can detect that the participation requesting terminal (terminal 10ad) will participate in the content data session.

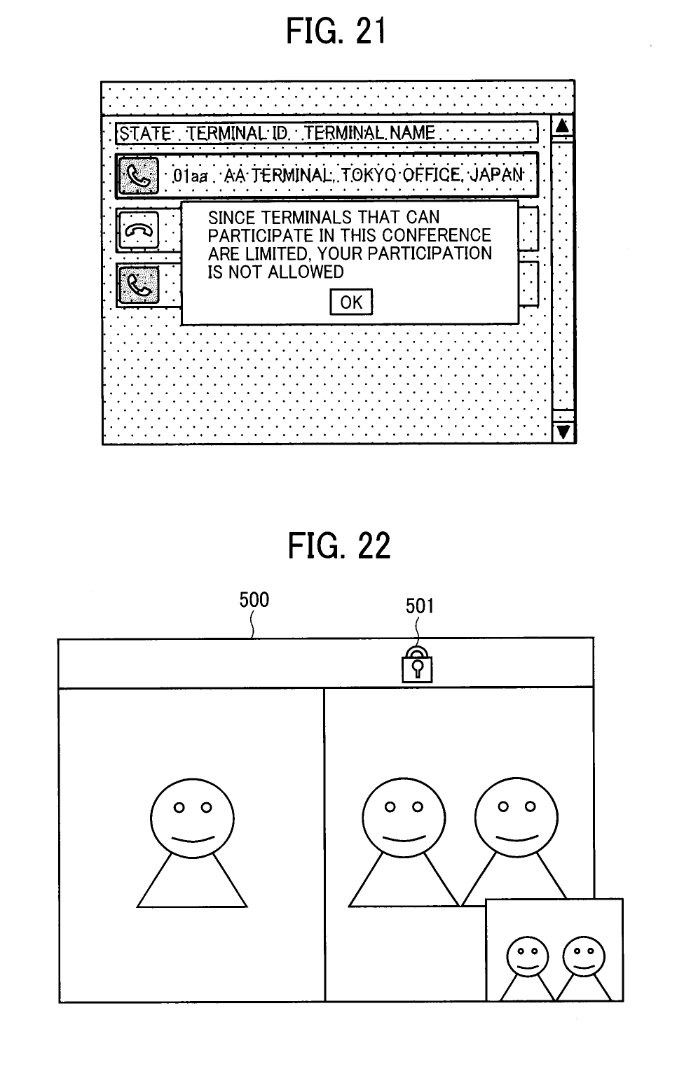

Note that FIG. 22 is an illustration of an example of a display screen of the display 120 of a terminal 10 in a conference where participatable terminals are limited. The display screen has an area 500 for displaying various types of information, and the display control 16 can display an icon 501 indicating that this is a participant-limited conference in the area 500. Accordingly, participates in the conference can see that the conference being held is a participant-limited conference. Note that the display control 16 may not constantly display the icon 501. For example, the display control 16 may enlarge and display the icon 501 at the start of the conference or when a participant participates in the conference after the conference has started, and may minimize and continuously display the icon 501 after a certain time (such as after 10 seconds) has elapsed, while enlarging the area of a conference screen. In doing so, the quality of the conference screen can be improved.

As has been described above, according to the embodiment of the present invention, even in the case where a communication terminal is identified as a communication terminal that can participate in a limited session between communication terminals, the session control system performs control to enable this communication terminal to participate in another session before participating in the former-mentioned session. Accordingly, the communication terminal can participate in another session before participating in the limited session. In doing so, the communication terminal can be effectively utilized.

For example, in the case where communication terminals that can participate in a session between communication terminals are limited, a communication terminal is unable to perform communication in another session during a limited period. Therefore, even in the case where a communication terminal participates in the session after the session has started, the communication terminal is unable to perform other communication during a limited period. Accordingly, the communication terminal cannot be effectively used. According to the above-described embodiment, a communication terminal can participate in another session before participating in a limited session.

The relay devices 30, the communication management system 50, the communication terminal management system 80, the program providing system 90, and the maintenance system 100 in the above-described embodiment may be configured by a single computer or a plurality of computers to which divided portions (functions) are arbitrarily allocated. In addition, in the case where the program providing system 90 is configured by a single computer, a program transmitted by the program providing system 90 may be separately transmitted in units of a plurality of modules, or may be transmitted in its entirety. Further, in the case where the program providing system 90 is configured by a plurality of computers, a program may be divided into a plurality of modules, and the modules may be individually transmitted from the respective computers.

In addition, a recording medium storing the terminal program, relay device program, communication management program, or communication terminal management system program in the above-described embodiment, the HD 204 storing these programs, and the program providing system 90 including the HD 204 are each used in the case where the terminal program, relay device program, communication management program, or communication terminal management system program is provided as a program product to users within a certain country or outside that country.

In addition, although the case of a videoconference system has been described as an example of the communication system 1 in the above-described embodiment, the embodiment is not limited to this case, and the communication system 1 may be a phone system such as an IP phone system or an Internet phone system. In addition, the communication system 1 may be a car navigation system. In this case, for example, one of two terminals 10 corresponds to a car navigation apparatus mounted on a car, and the other terminal 10 corresponds to a management terminal or a management server of a management center that manages car navigation, or a car navigation apparatus mounted on another car.

Further, the communication system 1 may be a cellular phone communication system. In this case, for example, the terminals 10 correspond to cellular phones.

In addition, although image data serving as sight data and sound data serving as hearing data are described as examples of content data in the above-described embodiment, the content data is not limited to these items of data, and the content data may be other five-sense data. For example, in the case where the content data is touch data, a feeling obtained by a user's contact at one terminal is transmitted to the other terminal side. Further, in the case where the content data is smell data, a smell at one terminal side is transmitted to the other terminal side. In addition, in the case where the content data is taste data, a taste at one terminal side is transmitted to the other terminal side.

Further, the content data may be at least one of image (sight) data, sound (hearing) data, touch data, smell data, and taste data.

In addition, although the case in which a videoconference is held by the communication system 1 has been described in the above-described embodiment, the embodiment is not limited to this case. The communication system 1 may be used in meetings, general conversation between family members or friends, or one-way presentation of information.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In one example, the present invention may reside in: a participatable terminal manager that manages, in a session for transmitting content data between communication terminals,

in a case where participatable communication terminals that can participate in the session are limited, participatable terminal identification information for identifying the participatable communication terminals; and

a session control that performs control to enable, based on the participatable terminal identification information, in a case where a communication terminal identified to be capable of participating in the limited session is not participating in the limited session, the communication terminal to participate in another session different from the limited session

1. A session control system comprising:
a memory configured to store limitation information for each one of a plurality of first sessions where participatable communication terminals that can participate in the session are limited, the limitation information including:
participatable terminal identification information for identifying each one of participatable communication terminals allowed to participate in the first session; and
participant terminal identification information for identifying each one of the participatable communication terminals that is participating in the first session;
a receiver configured to receive a request for starting a second session with a counterpart communication terminal by a first communication terminal; and
a processing circuitry configured to
determine whether the counterpart communication terminal is participating in any one of the first sessions using the participant terminal identification information, and
accept the request to enable the first communication terminal to start the second session with the counterpart communication terminal, when the counterpart communication terminal is not participating in any one of the first sessions.

2. The session control system of claim 1, wherein, when the counterpart communication terminal that is not participating in any one of the first sessions is one of the participatable communication terminals allowed to participate in the first session, the processing circuitry accepts the request to start the second session even during a time period in which the counterpart communication terminal is supposed to participate in the first session as the participatable communication terminal.

3. The session control system of claim 1, wherein, when the counterpart communication terminal that is not participating in any one of the first sessions participates in the first session, the processing circuitry rejects the request to start the second session.

4. The session control system of claim 3, wherein
the processing circuitry updates the limitation information to additionally include the participant terminal identification information of the counterpart communication terminal that participates in the first session, in response to participation of the counterpart communication terminal in the first session.

5. The session control system of claim 1, wherein
the processing circuitry deletes, from the limitation information, the participant terminal identification information of the participatable communication terminals that are participating in the first session, when a predetermined time period has elapsed.

6. The session control system of claim 5, wherein the limitation information further includes time information indicating a time at which limitation that limits communication terminals that can participate to the participatable communication terminals of the limitation information is removed,
wherein the predetermined time period is determined based on the time information.

7. The session control system of claim 1, further comprising:
a transmitter that transmits, in response to a candidate list request from the first communication terminal, a list of participatable communication terminals allowed to participate in at least one of the first sessions that the first communication terminal can participate, to the first communication terminal as the candidate list,
wherein the counterpart communication terminal is selected from the candidate list.

8. A communication system, comprising:
the session control system of claim 1; and
the first communication terminal that starts the second session with the counterpart communication terminal, when the request is accepted.

9. The communication system of claim 7, further comprising:
a second communication terminal that sends the request for starting the second session by the first communication terminal, to the session control system.

10. A method of controlling a session, comprising:
storing, in a memory, limitation information for each one of a plurality of first sessions where participatable communication terminals that can participate in the session are limited, the limitation information including:
participatable terminal identification information for identifying each one of participatable communication terminals allowed to participate in the first session; and
participant terminal identification information for identifying each one of the participatable communication terminals that is participating in the first session;
receiving a request for starting a second session with a counterpart communication terminal by a first communication terminal;
determining whether the counterpart communication terminal is participating in any one of the first sessions using the participant terminal identification information, and
accepting the request to enable the first communication terminal to start the second session with the counterpart communication terminal, when the counterpart communication terminal is not participating in any one of the first sessions.

11. The method of claim 10, wherein, when the counterpart communication terminal that is not participating in any one of the first sessions is one of the participatable communication terminals allowed to participate in the first session, the method further comprising:
accepting the request to start the second session even during a time period in which the counterpart communication terminal is supposed to participate in the first session as the participatable communication terminal.

12. The method of claim 10, wherein, when the counterpart communication terminal that is not participating in any one of the first sessions participates in the first session, the method further comprising:
rejecting the request to start the second session.

13. The method of claim 12, further comprising:
updating the limitation information to additionally include the participant terminal identification information of the counterpart communication terminal that participates in the first session, in response to participation of the counterpart communication terminal in the first session.

14. The method of claim 10, further comprising:
deleting, from the limitation information, the participant terminal identification information of the participatable communication terminals that are participating in the first session, when a predetermined time period has elapsed.

15. A non-transitory recording medium storing a plurality of instructions which, when executed by one or more processors, cause the processors to perform a session control method comprising:
storing, in a memory, limitation information for each one of a plurality of first sessions where participatable communication terminals that can participate in the session are limited, the limitation information including:
participatable terminal identification information for identifying each one of participatable communication terminals allowed to participate in the first session; and
participant terminal identification information for identifying each one of the participatable communication terminals that is participating in the first session;
receiving a request for starting a second session with a counterpart communication terminal by a first communication terminal;
determining whether the counterpart communication terminal is participating in any one of the first sessions using the participant terminal identification information, and
accepting the request to enable the first communication terminal to start the second session with the counterpart communication terminal, when the counterpart communication terminal is not participating in any one of the first sessions.
